(19) United States
(12) Patent Application Publication
(10) Pub. No.: US 2013/0002659 A1
(43) Pub. Date: Jan. 3, 2013

(54) GRAPHICS PROCESSING UNIT-BASED FAST CONE BEAM COMPUTED TOMOGRAPHY RECONSTRUCTION

(75) Inventors: Steve B. Jiang, San Diego, CA (US); Xun Jia, San Diego, CA (US)

(73) Assignee: The Regents of the University of California, Oakland, CA (US)

(21) Appl. No.: 13/578,693

(22) PCT Filed: Feb. 14, 2011
(86) PCT No.: PCT/US11/24803

§ 371 Date: Sep. 13, 2012

Related U.S. Application Data
(60) Provisional application No. 61/304,353, filed on Feb. 12, 2010.

(51) Int. Cl. G06F 15/16; G06T 15/00; G06K 9/00; G06F 15/00

(52) U.S. Cl. 345/419; 345/501; 382/131; 345/502

(57) ABSTRACT

Techniques, apparatus and systems are disclosed for performing graphics processor unit (GPU)-based fast cone beam computed tomography (CBCT) reconstruction algorithm based on a small number of x-ray projections. In one aspect a graphics processor unit (GPU) implemented method of reconstructing a cone beam computed tomography (CBCT) image includes receiving, at the GPU, image data for CBCT reconstruction. The GPU uses an iterative process to minimize an energy functional component of the received image data. The energy functional component includes a data fidelity term and a data regularization term. The reconstructed CBCT image is generated based on the minimized energy functional component.

### CLAIM OF PRIORITY

This application claims priority to U.S. Provisional Patent Application No. 61/304,353, filed Feb. 12, 2010, entitled “Graphics Processing Unit-Based Fast Cone Beam Computed Tomography Reconstruction,” the entire contents of which are incorporated by reference.

### BACKGROUND

This application relates to computed tomography technology.

Cone Beam Computed Tomography (CBCT) reconstruction is one of the central topics in medical image processing. In CBCT, the patient's volumetric information is retrieved based on its x-ray projections in a cone beam geometry along a number of directions. Examples of the CBCT reconstruction algorithms include filtered back projection (FBP) algorithm and other reconstruction algorithms, such as EM and ART/SART. Among its many applications, CBCT is particularly convenient for accurate patient setup in cancer radiotherapy.

### SUMMARY

Techniques, apparatus and systems are described for implementing a fast GPU-based CBCT reconstruction algorithm based on a small number of x-ray projections to lower radiation dose.

In one aspect a graphics processor unit (GPU) implemented method of reconstructing a cone beam computed tomography (CBCT) image includes receiving, at the GPU, image data for CBCT reconstruction. The GPU uses an iterative process to minimize an energy functional component of the received image data. The energy functional component includes a data fidelity term and a data regularization term. The reconstructed CBCT image is generated based on the minimized energy functional component.

Implementations can optionally include one or more of the following features. The received image data can include volumetric information projected using x-ray projections onto an x-ray imager plane in a cone beam geometry along a number of projection angles. The fidelity term can indicate consistency between the reconstructed CBCT image and an observed image from the number of projection angles. The data regularization term can include a total variation regularization term. Using the iterative process to minimize an energy functional component of the received image data can include using an algorithm that minimizes the data regularization term and the data fidelity term in two alternating steps. The algorithm that minimizes the data regularization term and the data fidelity term in two alternating steps can include an iterative algorithm. The iterative algorithm can include (a) performing a gradient descent update with respect to minimization of the data fidelity term; (b) performing Rudin-Osher-Fatemi model minimization to remove noise and artifacts while preserving sharp edges and main features; (c) performing truncation to ensure non-negativeness of the reconstructed image; and (d) repeating (a)-(c) until a desired minimization of the energy functional component is reached.

In another aspect, a computer implemented method of reconstructing a cone beam computed tomography (CBCT) image includes receiving, at the computer, image data for CBCT reconstruction. An iterative conjugate gradient least square (CGLS) algorithm is used to minimize an energy functional component. The reconstructed CBCT image is generated based on the minimized energy functional component.

Implementations can optionally include one or more of the following features. The received image data can include volumetric information projected using x-ray projections onto an x-ray imager plane in a cone beam geometry along a number of projection angles. The iterative CGCL algorithm can begin with an initial guess and repeatedly minimizes the energy functional component until the reconstructed CBCT image is obtained. The iterative CGCL algorithm can ensure consistency between the reconstructed CBCT image and an observation image from the number of projection angles. The iterative CGCL algorithm can impose a tight frame regularization condition. Imposing a tight frame regularization condition can include decomposing the reconstructed image into a set of coefficients using a convolution function. The computer implemented method can be performed by a graphics processing unit (GPU).

In another aspect, a computing system for reconstructing a cone beam computed tomography (CBCT) image includes a graphics processing unit (GPU) to perform CBCT reconstruction. The CBCT reconstruction performed by the GPU includes receiving image data for CBCT reconstruction. The CBCT reconstruction performed by the GPU includes using an iterative process to minimize an energy functional component of the received image data. The energy functional component includes a data fidelity term and a data regularization term. The CBCT reconstruction performed by the GPU includes generating the reconstructed CBCT image based on the minimized energy functional component. The computing system includes a central processing unit (CPU) to receive the generated CBCT image for output.

Implementations can optionally include one or more of the following features. The received image data can include volumetric information projected using x-ray projections onto an x-ray imager plane in a cone beam geometry along a number of projection angles. The fidelity term can indicate consistency between the reconstructed CBCT image and an observed image from the number of projection angles. The data regularization term can include a total variation regularization term. The iterative process to minimize an energy functional component of the received image data can include an algorithm that minimizes the data regularization term and the data fidelity term in two alternating steps. The algorithm that minimizes the data regularization term and the data fidelity term in two alternating steps can include an iterative algorithm that includes (a) a gradient descent update with respect to minimization of the data fidelity term; (b) Rudin-Osher-Fatemi model minimization to remove noise and artifacts while preserving sharp edges and main features; (c) truncation to ensure non-negativeness of the reconstructed image; and (d) repeating (a)-(c) until a desired minimization of the energy functional component is reached.

In another aspect, a computing system for reconstructing a cone beam computed tomography (CBCT) image includes a graphics processing unit (GPU) to perform the CBCT reconstruction. The GPU is configured to perform the CBCT reconstruction including receiving image data for CBCT reconstruction. The GPU is configured to perform the CBCT reconstruction including using an iterative conjugate gradient least square (CGLS) algorithm to minimize an energy functional component. The GPU is configured to perform the CBCT reconstruction including generating the reconstructed CBCT image based on the minimized energy functional component. The computing system includes a central processing unit (CPU) to receive the reconstructed CBCT image for output.

Implementations can optionally include one or more of the following features. The received image data can include volumetric information projected using x-ray projections onto an x-ray imager plane in a cone beam geometry along a number of projection angles. The GPU can be configured to perform the iterative CGCL algorithm by beginning with an initial guess and repeatedly minimizes the energy functional component until the reconstructed CBCT image is obtained. The iterative CGCL algorithm can ensure consistency between the reconstructed CBCT image and an observation image from the number of projection angles. The GPU can use the iterative CGCL algorithm to impose a tight frame regularization condition. The GPU can be configured to impose the tight frame regularization condition by decomposing the reconstructed image into a set of coefficients using a convolution function.

The subject matter described in this specification potentially can provide one or more of the following advantages. For example, the described techniques, apparatus and systems can be used to implement fast graphics processing unit (GPU)-based low-dose cone beam computed tomography (CT) reconstruction via total variation regularization. In the described low-dose CBCT reconstruction implementation, the CBCT image is reconstructed by minimizing an energy functional that includes a Total Variation (TV) regularization term and a data fidelity term. An algorithm can be implemented to efficiently perform the optimization process via a proximal forward-backward splitting method and a multi-grid technique. Furthermore, the described reconstruction algorithm can be fully implemented on graphics processing unit (GPU), ensuring satisfactory computational speed. The powerful minimization algorithm, as well as the GPU implementation, can provide both sufficient reconstruction accuracy and satisfactory efficiency. In particular, the reconstruction time can range from 0.5 to 5 minutes depending on the number of x-ray projections used, a significant improvement over currently similar reconstruction approaches.

Also, the described techniques can provide CBCT reconstructions with a greatly reduced number of noisy projections, while maintaining high image quality. In addition, the reconstruction process can be sped up by utilizing a better optimization algorithm and a more powerful computational hardware. For example, general purpose graphic processing units (GPUs) can be used to speed up heavy duty tasks in radiotherapy, such as CBCT reconstruction, deformable image registration, dose calculation, and treatment plan optimization.

### BRIEF DESCRIPTION OF THE DRAWINGS

FIG. 1 shows geometry of x-ray projection.

FIG. 2 is a process flow diagram of a process for performing the above described GPU-based CBCT reconstruction algorithm.

FIG. 3 shows a phantom generated at thorax region with a size of 512×512×70 voxels and the voxel size is chosen to be 0.88×0.88×0.88 mm³.

FIG. 4 shows three slice cuts of an NCAT phantom used in CBCT reconstruction as well as a typical x-ray projection along the AP direction.

FIG. 5 shows an axial view of the reconstructed CBCT image under N_{θ}=5, 10, 20, and 40 x-ray projections.

FIG. 6 shows three orthogonal planes of the final reconstructed image with N_{θ}=40 projections on the left column.

FIG. 7 shows a plot of relative error e as a function of iteration step with and without using the multi-grid technique.

FIG. 8 shows axial views of the reconstructed images of a CatPhan phantom from N_{θ}=40 projections at four axial slices based on the described method (top row) and the FDK method (bottom row) at 2.56 mAs/projection.

FIG. 9 shows an axial view of the reconstructed CBCT images of a CatPhan phantom at various mAs levels (0.10, 0.30, 1.00 and 2.56) for N_{θ}=40 projections.

FIG. 10 shows the results in this case from the described algorithm as well as from the convential FDK algorithm.

FIG. 11 shows reconstructed images of a Rando head phantom from N_{θ}=40 x-ray projections based on the described method (top row) and the FDK method (bottom row).

FIG. 12 shows CBCT reconstruction results represented under different mAs levels ranging from 0.1 mAs/projection to 2.0 mAs/projection.

FIG. 13 illustrates another geometry of x-ray projection.

FIG. 14 shows a central slice of a reconstructed CBCT image using the described TF-based algorithm and the ground truth image; and corresponding comparison of image profiles.

FIG. 15 shows reconstruction images using the TF algorithm and zoomed-in images respectively.

FIG. 16 shows a transverse slice of the Calphan phantom used to measure MTF and a transverse slice of the Calphan phantom used to measure CNR.

FIG. 17a shows two patches used to measure MTF in CBCT images reconstructed from TF and FDK algorithms at 1.0 mAs/projection with 40 projections.

FIG. 17b shows MTF measurements obtained from different methods.

FIG. 17c shows three patches used to measure MTF in CBCT images reconstructed from TF method at 1.0, 0.3, and 0.1 mAs/projections with 40 projections.

FIG. 17d shows MTF measured at different mAs levels.

FIG. 18a shows results of taking a case at 0.3 mAs/projection and 40 projections as an example.

FIG. 18b shows the dependence of CNRs on mAs levels measured in those four ROIs in the CBCT images reconstructed using the TF method.

FIG. 18c shows corresponding CNRs obtained from the conventional FDK algorithm.

FIG. 19 shows two transverse slices and one sagittal slice of a real head-and-neck patient CBCT reconstructed from TF method with μ=5×10⁻² (first row), μ=2.5×10⁻² (second row), and the conventional FDK algorithm (third row) using 40 projections.

FIG. 20 is a block diagram of a computing system 2000 for performing the CBCT reconstruction.

Like reference symbols and designations in the various drawings indicate like elements.

### DETAILED DESCRIPTION

In one aspect, techniques, apparatus and systems are described for implementing fast graphics processing unit (GPU)-based low-dose cone beam computed tomography (CT) reconstruction via total variation regularization. In the described low-dose GPU-based CBCT reconstruction implementation, CBCT images can be reconstructed by minimizing an energy functional that includes a TV regularization term and a data fidelity term posed by the x-ray projections. By developing new minimization algorithms with mathematical structures suitable for GPU parallelization, the massive computing power of GPU can be adapted to dramatically improve the efficiency of the TV-based CBCT reconstruction.

For example, an algorithm can be implemented to efficiently perform the optimization process via a proximal forward-backward splitting method and a multi-grid technique. Furthermore, the described reconstruction algorithm can be fully implemented on graphics processing unit (GPU), ensuring satisfactory computational speed. Tests results of the CBCT reconstruction on a digital phantom are described below. The powerful minimization algorithm, as well as the GPU implementation, can be combined to provide both sufficient reconstruction accuracy and satisfactory efficiency. In particular, the reconstruction time can range from 0.5 to 5 minutes depending on the number of x-ray projections used.

### Model for TV-Based CBCT Reconstruction Algorithms

For a patient volumetric image represented by a function ƒ(x, y, z), where (x, y, z) εR³ is a vector in 3-dimensional Euclidean space. A projection operator P^{θ} maps ƒ(x, y, z) into another function on an x-ray imager plane along a projection angle θ.

P^{θ}[ƒ(x,y,z)](u,v)=∫₀^{L(u,v)}dlf(xₛ+n₁l,ys+n₂l,zs+n₃l) (1)

where (xₛ,yₛ,zₛ) is the coordinate of the x-ray source S and (u,v) is the coordinate for a point P on the imager, n=(n₁,n₂,n₃) being a unit vector along the direction SP.

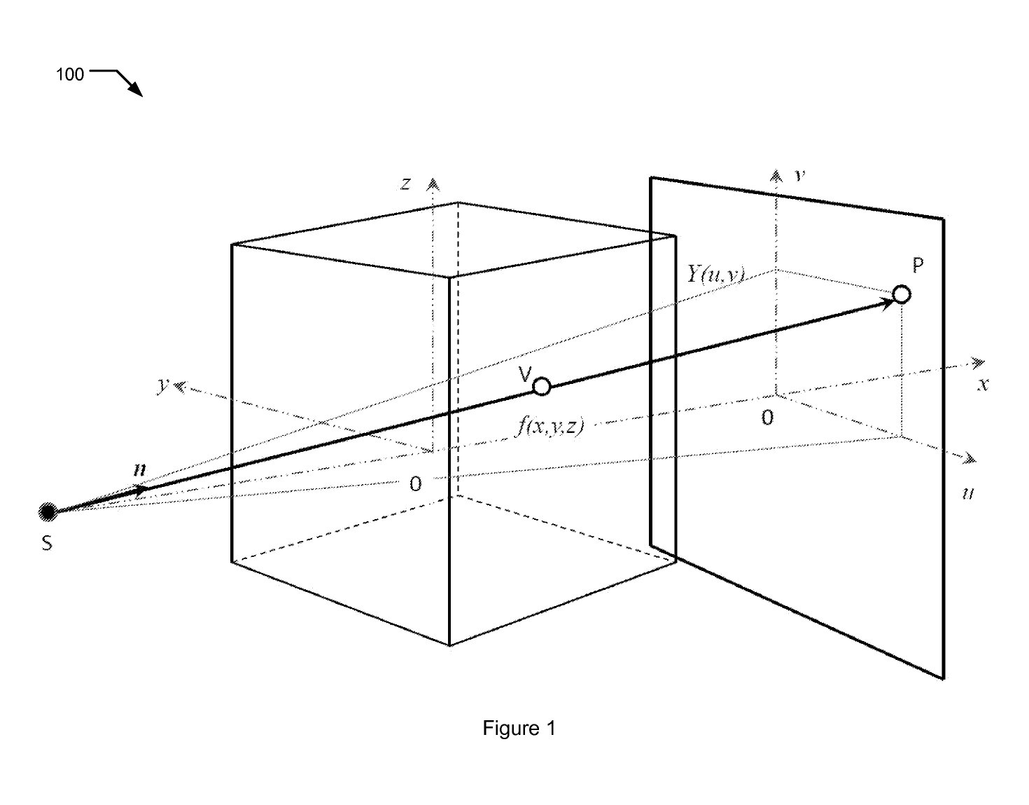

FIG. 1 shows a geometry of x-ray projection. The operator P^{θ} maps ƒ(x,y,z) in R³ onto another function P^{θ}[ƒ(x,y,z)](u,v) in R², the x-ray imager plane, along a projection angle θ. L(u,v) is the length of SP and I(x,y,z) is that of SV. The source to imager distance is L₀. The upper integration limit L(u,v) is the distance from the source S to the point P. Denote the observed projection image at an angle θ by Y^{θ}(u,v). A CBCT reconstruction problem is formulated as to retrieve the volumetric image function ƒ(x,y,z) based on the observation of Y^{θ} (u,v) at various angles given the projection mapping in Eq. (1).

The CBCT image can be reconstructed by minimizing an energy functional consisting of a data fidelity term and a regularization term:

f(x,y,z)=argmin E[f]=argminE₁[f]+μE₂[f],s.t.f.(x,y,z)≧0for ∀(x,y,z)εR³, (2)

where the energy functionals are

$${E}_{1} [ f ] = \frac{1}{V} {‖ ∇ f ‖}_{1}$$

and

$${E}_{2} [ f ] = \frac{1}{{N}_{θ} A} {\sum }_{θ} {‖ {p}^{θ} [ f ] - {Y}^{θ} ‖}_{2}^{2} .$$

Here V is the volume in which the CBCT image is reconstructed. N_{θ} is the number of projections used and A is the projection area on each x-ray imager. ∥ . . . ∥_{⇓}, p denotes Iₚ− norm of functions. In Eq. (2), the data fidelity term E₂[ƒ] ensures the consistency between the reconstructed volumetric image ƒ(x,y,z) and the observation Y^{θ}(u,v). The first term, E₁[f], known as TV semi-norm, can be extremely powerful to remove artifacts and noise from f while preserving its sharp edges to a certain extent. The CBCT image reconstruction from few projections is an underdetermined problem in that there are infinitely many functions f such that P^{θ}[ƒ(x,y,z)](u,v)=Y^{θ}(u,v). By performing the minimization as in Eq. (2), the projection condition can be satisfied to a good approximation. The TV regularization term can serve as the purpose of picking out the one with desired image properties, namely smooth while with sharp edges, among those infinitely many candidate solutions. The dimensionless constant μ>0 controls the smoothness of the reconstructed images by adjusting the relative weight between E₁[f] and E₂[ƒ]. In the reconstruction results shown herein, the value of μ can be chosen manually for the best image quality.

### Minimization Algorithm

One of the obstacles encountered while solving Eq. (2) comes from the projection operator P^{θ}. In matrix representation, this operator is sparse. However, it contains approximately 4×10⁹ non-zero elements for a typical clinical case studied in this paper, occupying about 16 GB memory space. This matrix is usually too large to be stored in typical computer memory and therefore it has to be computed repeatedly whenever necessary. This repeated work can consume a large amount of the computational time. For example, if Eq. (2) is solved with a simple gradient descent method, P^{θ} would have to be evaluated repeatedly while computing the search direction, i.e. negative gradient, and while calculating the functional value for step size search. This could significantly limit the computation efficiency.

To overcome this difficulty, the forward-backward splitting algorithm can be used. This algorithm splits the minimization of the TV term and the data fidelity term into two alternating steps, while the computation of x-ray projection P^{θ} is only in one of them. The computation efficiency can be improved owing to this splitting. Consider the optimality condition of Eq. (2) by setting the functional variation with respect to ƒ(x,y,z) to be zero:

$$\frac{δ}{δ f ( x , y , x )} {E}_{1} [ f ] + μ \frac{δ}{δ f ( x , y , z )} {E}_{2} [ f ] = 0. \qquad ( 3 )$$

If the above equation is split into the following form

$$\begin{matrix}μ \frac{δ}{δ f ( x , y , z )} {E}_{2} [ f ] = \frac{β}{V ( f - g )} , & ( 4 ) \\ \frac{δ}{δ f ( x , y , z )} {E}_{1} [ f ] = \frac{β}{V} ( f - g ) , & \end{matrix}$$

where β>0 is a parameter and g(x,y,z) is an auxiliary function used in this splitting algorithm, the minimization problem can be accordingly split, leading to the following iterative algorithm to solve Eq. (2):

Algorithm A1:

```
Do the following steps until convergence
  $1. Update \text{:} g = f - \frac{μ V}{β} \frac{δ}{δ f ( x , y , z )} {E}_{2} [ f ] ;$
  $2. Minimize \text{:} f = arg min {E}_{1} [ f ] + \frac{β}{2} {E}_{2} [ f ] ;$
  3. Correct: f(x, y, z) = 0, if f(x, y, z) < 0,.
```

Here a new energy functional can be described as

$${E}_{1} [ f ] = \frac{1}{V} {‖ f - g ‖}_{2}^{2} .$$

Step 1 in Algorithm A1 is a gradient descent update with respect to the minimization of energy functional E₂[ƒ]. Also, Step 2 here is just an Rudin-Osher-Fatemi model, which has been shown to be extremely efficient and capable of removing noise and artifacts from a degraded image g(x,y,z) while still preserving the sharp edges and main features. In addition, since ƒ represents the x-ray attenuation coefficients, its non-negativeness can be ensured by a simple truncation as in Step 3.

The choice of β can be important in this algorithm. On one hand, a small value of β can lead to a large step size of the gradient descent update in Step 1, causing instability of the algorithm. On the other, a large β may tend to make the TV semi-norm E₁[ƒ] unimportant in Step 2, reducing its efficacy in removing artifacts. In practice, an empirical value β˜10μ can be appropriate.

For the sub-problem in Step 2, the optimization of an energy functional E_{ROF}[ƒ]=E₁[ƒ]+(β/2)E₃[ƒ] can be solved by a simple gradient descent method. At each iteration step of the gradient descent method, the functional value E₀=E_{ROF}[ƒ] can be first evaluated, as well as the functional gradient

$$d ( x , y , z ) = \frac{δ}{δ f ( x , y , z )} {E}_{ROF} [ f ] .$$

An inexact line search can be then performed along the negative gradient direction with an initial step size λ=λ₀. The trial functional value E_{new}=E_{ROF}[ƒ−λd] can be evaluated. If Amijo's rule is satisfied, namely

$$E [ f - λ d ] \leq {E}_{0} - c λ \frac{1}{V} \int d x d y d z d {( x , y , z )}^{2} , \qquad ( 5 )$$

where c is a constant, the step size λ is accepted and an update of the image ƒ←ƒ−λd is applied; otherwise, the search step size is reduced by a factor α with αε (0,1). This iteration can be repeated until the relative energy decrease in a step

$$\frac{\vert {E}_{new} - {E}_{0} \vert}{{E}_{0}}$$

is less than a given threshold ε. The parameters relevant in this sub-problem can be chosen as empirical values of c=0.01, α=0.6 and ε=0.1%. The computation results are found to be insensitive to these choices.

Boundary condition can be also addressed during the implementation. For simplicity, zero boundary condition can be imposed in the described computation along the anterior-posterior direction and the lateral direction, while reflective boundary condition can be used along the superior-inferior direction.

### GPU Implementation

Computer graphic cards, such as the NVIDIA GeForce series and the GTX series, can be used for display purpose on desktop computers. However, special GPUs dedicated for scientific computing, for example the Tesla C1060 card (from NVIDIA of Santa Clara, Calif.) can be used for implementing the CBCT algorithms described herein. A scientific computing dedicated GPU card can have multiple processor cores (e.g., a total number of 240 processor cores grouped into 30 multiprocessors with 8 cores each), each with a clock speed of 1.3 GHz. The card can be equipped with 4 GB DDR3 memory, shared by all processor cores. Utilizing such a GPU card with tremendous parallel computing ability can considerably elevate the computation efficiency of the described algorithm. In fact, a number of components can be easily accomplished in a parallel fashion. For instance, the evaluating of functional value E_{ROF}[ƒ] in Step 2 of Algorithm A1 can be performed by first evaluating its value at each (x,y,z) coordinate and then summing over all coordinates. The functional gradient d(x,y,z) can be also computed with each GPU thread responsible for one coordinate.

### Closed-Form Gradient

A straightforward way of implementing Algorithm A1 can include interpretation of

P^{θ}[ƒ] as a matrix multiplication and then E₂[ƒ] as a vector norm

$${\sum }_{θ} {‖ {P}^{θ} f - {Y}^{θ} ‖}_{2}^{2} .$$

This leads to a simple form

$${\sum }_{θ} {P}^{{θ}^{T}} ( {P}^{θ} f - {Y}^{θ} )$$

for the functional variation δE₂[ƒ]/8ƒ(x,y,z) in Step 1, apart from some constants, where ·^{T} denotes matrix transpose. In practice, P^{θ} may be too large to be stored in computer memory. Also, P^{θ}ƒ is simply a forward projection calculation that can be easily computed by a ray-tracing algorithm, such as Siddon's algorithm. Due to the massive parallelization ability of GPU, multiple threads can compute projections of a large number rays simultaneously and high efficiency can be achieved. On the other hand, an efficient algorithm to perform the operation of P^{θ}^{^{T}} can be lacking. In fact, P^{θ}^{^{T}} is a backward operation in that voxel values tend to be updated along a ray line. If this backward operation is performed by Siddon's algorithm in the GPU implementation with each thread responsible for updating voxels along a ray line, a memory conflict problem could take place due to the possibility of updating a same voxel by different GPU threads. As a consequence, one thread may have to wait until another one finishes updating. This can severely limit the exploitation of GPU's massive parallel computing power.

To overcome this difficulty, the functional variation

$$\frac{δ}{δ f ( x , y , z )} {E}_{2} [ f ]$$

in Step 1 of Algorithm A1 can be analytically computed and a closed-form equation can be obtained:

$$\frac{δ}{δ f ( x , y , z )} {E}_{2} [ f ] = \frac{1}{{N}_{θ} A} {\sum }_{θ} \frac{2 {L}^{3} ( {u}^{*} , {v}^{*} )}{{L}_{0} {l}^{2} ( x , y , z ) [ {P}^{θ} [ f ( x , y , z ) ] ( {u}^{*} , {v}^{*} ) - {Y}^{θ} ( {u}^{*} , {v}^{*} ) ]} . \qquad ( 6 )$$

Here (u*,v*) is the coordinate for a point P on imager, where a ray line connecting the source S=(xₛ, yₛ, zₛ) and the point V=(x,y,z) intersects with the imager. L₀ is the distance from the x-ray source S to the imager. I(x,y,z) and L(u*,v*) are the distance from S to the point V and from S to the point P, respectively. See FIG. 1 for the geometry. The derivation of Eq. (6) is briefly described below.

Without losing of generality, assume the x-ray projection is taken along positive x-direction. With the help of delta functions, Eq. (1) can be rewritten as:

P^{θ}[ƒ(x,y,z)](u,v)=∫dldxdydzf(x,y,z)·δ(x−xₛ−n₁l)δ(y−yₛ−n₂l)δ(z−zₛ−n₃l). (7)

From FIG. 1, the unit vector n=(n₁, n₂, n₃) can be expressed as:

$${n}_{1} = \frac{{L}_{0}}{L ( u , v )} , {n}_{2} = - \frac{u}{L ( u , v )} , {n}_{3} = \frac{v}{L ( u , v )} , \qquad ( 8 )$$

where L(u,v)=[L₀²+u²+v²]^{1/2}. For the functional E₂[ƒ] in Eq. (2), variation is taken with respect to ƒ(x,y,z), yielding

$$\frac{δ}{δ f ( x , y , z )} {E}_{2} [ f ] = \frac{1}{{N}_{θ} A} {\sum }_{θ} 2 \int d u d v d l [ {P}^{θ} [ f ( x , y , z ) ] ( u , v ) - {Y}^{θ} ( u , v ) ] \cdot δ ( x - {x}_{s} - {n}_{1} l ) δ ( y - {y}_{s} - {n}_{2} l ) δ ( z - {z}_{s} - {n}_{3} l ) . \qquad ( 8 )$$

The following functions can be defined.

$$\begin{matrix}{h}_{1} ( u , v , l ) = x - {x}_{s} - {n}_{1} l = x - {x}_{s} - \frac{{L}_{0}}{L ( u , v )} l , & ( 9 ) \\ {h}_{2} ( u , v , l ) = y - {y}_{s} - {n}_{2} l = y - {y}_{s} - \frac{u}{L ( u , v )} l , & \\ {h}_{3} ( u , v , l ) = z - {z}_{s} - {n}_{3} l = z - {z}_{s} - \frac{v}{L ( u , v )} l . & \end{matrix}$$

From the properties of delta function, it follows that

$$\frac{δ}{δ f ( x , y , z )} {E}_{2} [ f ] = \frac{1}{{N}_{θ} A} {\sum }_{θ} 2 [ {P}^{θ} [ f ( x , y , z ) ] ( {u}^{*} , {v}^{*} ) - {Y}^{θ} ( {u}^{*} , {v}^{*} ) ] \frac{1}{{\vert \frac{\partial ( {h}_{1} , {h}_{2} , {h}_{3} )}{\partial ( u , v , l )} \vert}_{( {u}^{*} , {v}^{*} , {l}^{*} )}} , \qquad ( 10 )$$

where (u*,v*,I*) is the solution to Eq. (9). Explicitly, the following is obtained:

$$\begin{matrix}{u}^{*} = \frac{( y - {y}_{s} ) {L}_{0}}{x - {x}_{s}} , & ( 11 ) \\ {v}^{*} = \frac{( z - {z}_{s} ) {L}_{0}}{x - {x}_{s}} , & \\ {l}^{*} = \frac{L ( {u}^{*} - {v}^{*} ) ( x - {x}_{s} )}{{L}_{0}} . & \end{matrix}$$

The geometric meaning of this solution is clear. l* is the distance from x-ray source to the point V=(x,y,z). (u*,v*) is the coordinate for a point P on imager, where a ray line connecting the source S=(xₛ,yₛ,zₛ) and the point V=(x,y,z) intersects with the imager. Finally, the Jacobian

$$\frac{\partial ( {h}_{1} , {h}_{2} , {h}_{3} )}{\partial ( u , v , l )}$$

in Eq. (10) can be evaluated. This somewhat tedious work yields a simple result:

$${\vert \frac{\partial ( {h}_{1} , {h}_{2} , {h}_{3} )}{\partial ( u , v , l )} \vert}_{( {u}^{*} , {v}^{*} , {l}^{*} )} = \frac{{L}_{o} {l}^{2} ( x , y , z )}{{L}^{3} ( {u}^{*} , {v}^{*} )} . \qquad ( 12 )$$

Substituting Equation (12) into equation (10) leads to Equation (6) above.

The form of Equation (6) suggests a very efficient way of evaluating this functional variation and hence accomplishing Step 1 in Algorithm A1 in a parallel fashion. For this purpose, the forward projection operation can be first performed and compute an auxiliary function defined as T^{θ}(u,v)≡[P^{θ}[ƒ(x,y,z)](u,v)−Y^{θ}(u,v)] for all (u,v) and θ. For a point (x,y,z) where we try to evaluate the functional variation, it suffices to take the function values of T^{θ}(u*,v*) at a (u*,v*) coordinate corresponding to the (x,y,z), multiply by proper prefactors, and finally sum over θ. In numerical computation, since T^{θ}(u,v) can only be evaluated at a set of discrete (u,v) coordinates and (u*,v*) does not necessarily coincide with these discrete coordinates, a bilinear interpolation is performed to get T^{θ}(u*,v*). Because the computation of T^{θ}(u,v) can be achieved in a parallel manner with each GPU thread responsible for a ray line and the evaluation of

$$\frac{δ}{δ f ( x , y , z )} {E}_{2} [ f ]$$

can be performed with each thread for a voxel (x,y,z), extremely high efficiency in Step 1 is expected given the vast parallelization ability of GPU.

### Multi-Grid Method

Another technique employed to increase computation efficiency is multi-grid method. Because of the convexity of the energy functional in Eq. (2), the minimization problem is equivalent to solving a set of nonlinear differential equations posed by the optimality condition as in Eq. (3). When solving a differential equation with a certain kind of finite difference scheme, the convergence rate of an iterative approach largely depends on the mesh grid size. In particular, the convergence rate is usually worsened when a very fine grid size is used. Moreover, finer grid also implies more number of unknown variables, significantly increasing the size of the computation task.

A multi-grid approach can be utilized to resolve these problems. When it is desired to reconstruct a volumetric CBCT image ƒ(x,y,z) on a fine grid Ωₕ of size h, a process can be started by solving the problem on a coarser grid Ω₂ₕ of size 2 h with the same iterative approach as in Algorithm A1. Upon convergence, the solution ƒ₂ₕ on Ω₂ₕ can be extended to the fine grid Ωₕ by, for example, a linear interpolation, and then the solution can be used as the initial guess of the solution on Ωₕ. Because of the decent quality of this initial guess, only few iteration steps of Algorithm A1 are needed to achieve the final solution on Ωₕ. This two-level idea can be used recursively. In practice, a 4-level multi-grid scheme can be implemented, e.g., the reconstruction can be sequentially achieved on grids Ω₈ₕ→Ω₄ₕ→Ω₂ₕ→Ωₕ. A considerably efficiency gain can be observed in the implementation.

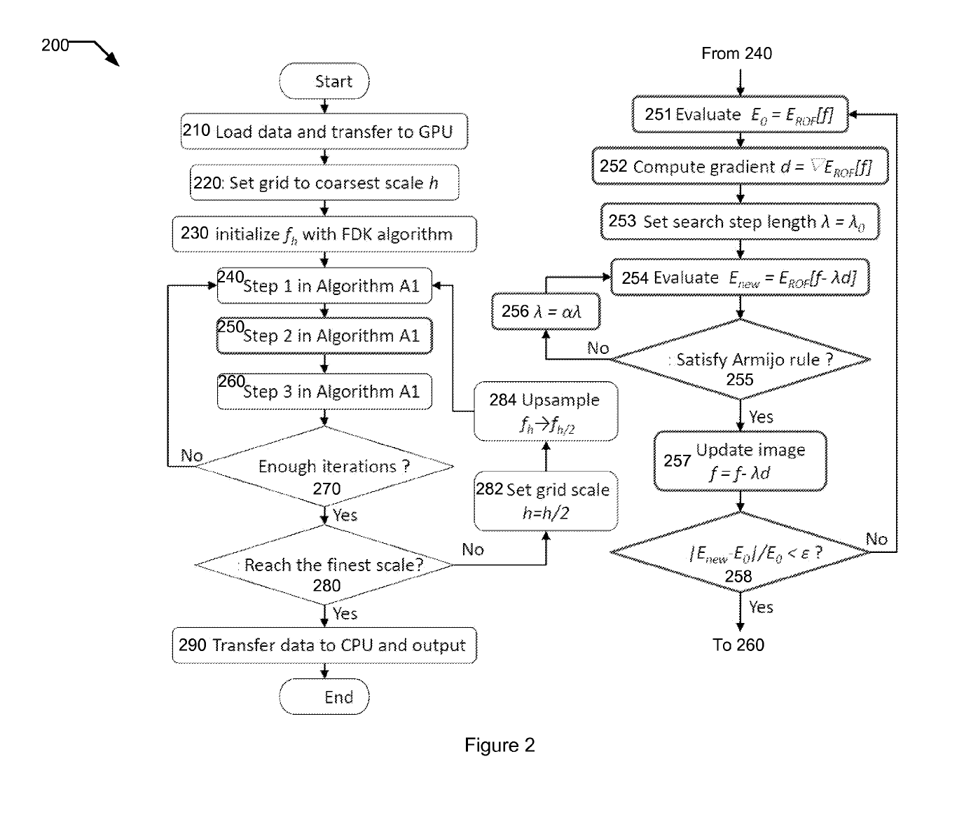

FIG. 2 is a process flow diagram of a process (200) for performing the above described GPU-based CBCT reconstruction algorithm. The process step 250 in the left panel is enlarged in detail in the right panel. At a computer system, data is loaded and transferred to a GPU (210). The GPU sets a grid to coarsest scale h (220). The GPU initializes ƒₕ with an FDK algorithm (230). The GPU performs the three steps of the Algorithm A1 described above are performed (240, 250 and 260 respectively.) The GPU determines or detects whether enough iterations have been performed (270). When the GPU detects or determines that enough iteration has not been performed, the process returns to Step 1 of Algorithm A1. When the GPU detects or determines that enough iterations have been performed, the GPU determines or detects whether the finest scale has been reached (280). When the GPU detects or determines that the finest scale has not been reached, the grid scale is set as h=h/2 (282). Up sampling is performed so that ƒₕ→ƒ_{h/2} (284), and the process returns to Step 1 of the Algorithm A1. When the GPU detects or determines that the finest scale has been reached, data is transferred from GPU to the CPU and outputted (290).

The process performed in Step 2 (250) above is further described in the flow chart on the right side of FIG. 2. For example, the GPU evaluates the expression E₀=E_{ROF}[f] (251). The GPU computes the gradient d=∇E_{ROF}[ƒ] (252). The GPU sets the search step length as λ=λₒ (253). The GPU evaluates the expression E_{new}=E_{ROF}[ƒ−λ_{d}] (254). The GPU determines or detects whether the Amijo rule has been satisfied (255). When the Amijo rule has not been satisfied, the GPU sets the search step length as λ=αλ (256) and reevaluates the expression E_{new}=E_{ROF}[ƒ−λ_{d}] (254). When the Amijo rule has been satisfied, the image is updated so that ƒ=ƒ−λ_{d}(257). Then the GPU detects or determines whether the expression |E_{new}−E_{O}|/E_{O}<ε is true (280). When |E_{new}−E_{O}|/E_{O} is not less than ε, process 250 returns to evaluate the expression E_{O}=E_{ROF}[ƒ] (251). When |E_{new}−E_{O}|/E_{O} is less than E, the process continues to Step 3 of Algorithm A1 above (260).

### Digital Phantom

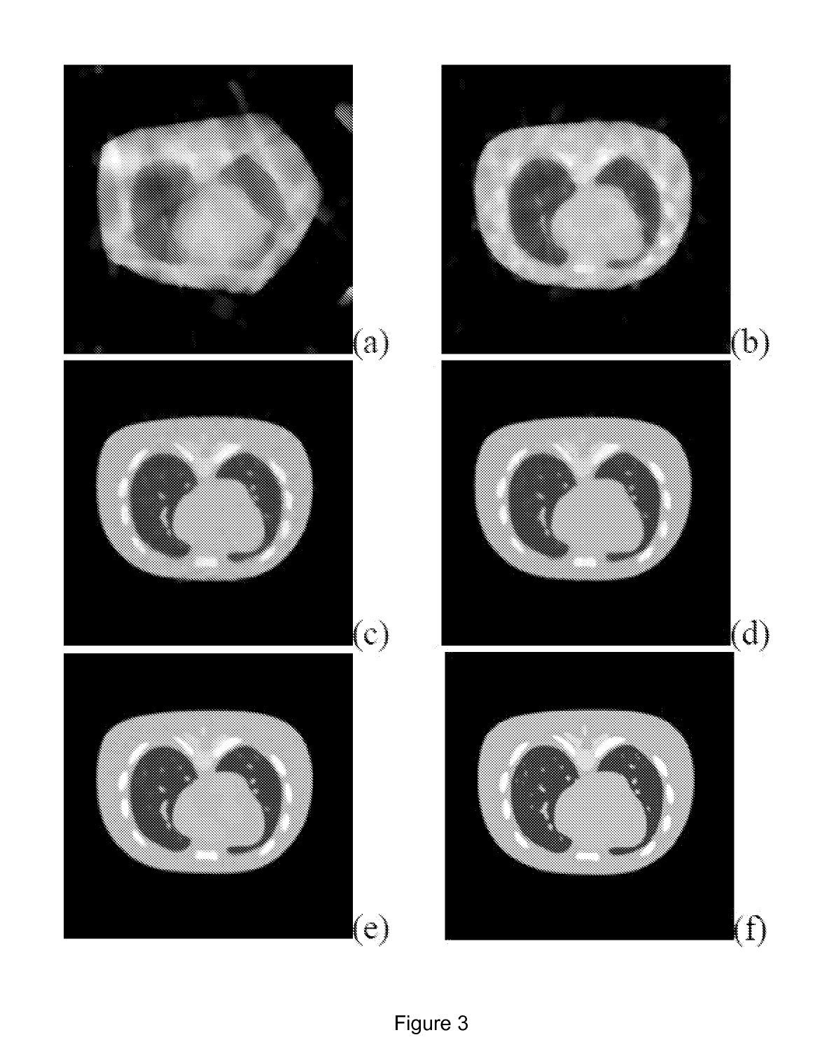

The above described reconstruction algorithm can be tested with a digital NURBS-based cardiac-torso (NCAT) phantom, which maintains a high level of anatomical realism (e.g., detailed bronchial trees). For example, FIG. 3 shows a phantom generated at thorax region with a size of 512×512×70 voxels and the voxel size is chosen to be 0.88×0.88×0.88 mm³. Panels (a-e) show axial views of the reconstructed CBCT image under N_{θ}=5, 15, 30, 40, 60 x-ray projections respectively. Panel (f) shows a ground-truth image.

For FIG. 3, the x-ray imager is modeled to be an array of 512×384 detectors covering an area of 76.8×15.3 cm². The source to axes distance is 100 cm and the source to detector distance is 150 cm. X-ray projections of the phantom are generated along various directions and are then used as the input for the reconstruction. As shown in FIG. 3, the reconstructed image becomes visually better as more projections are used.

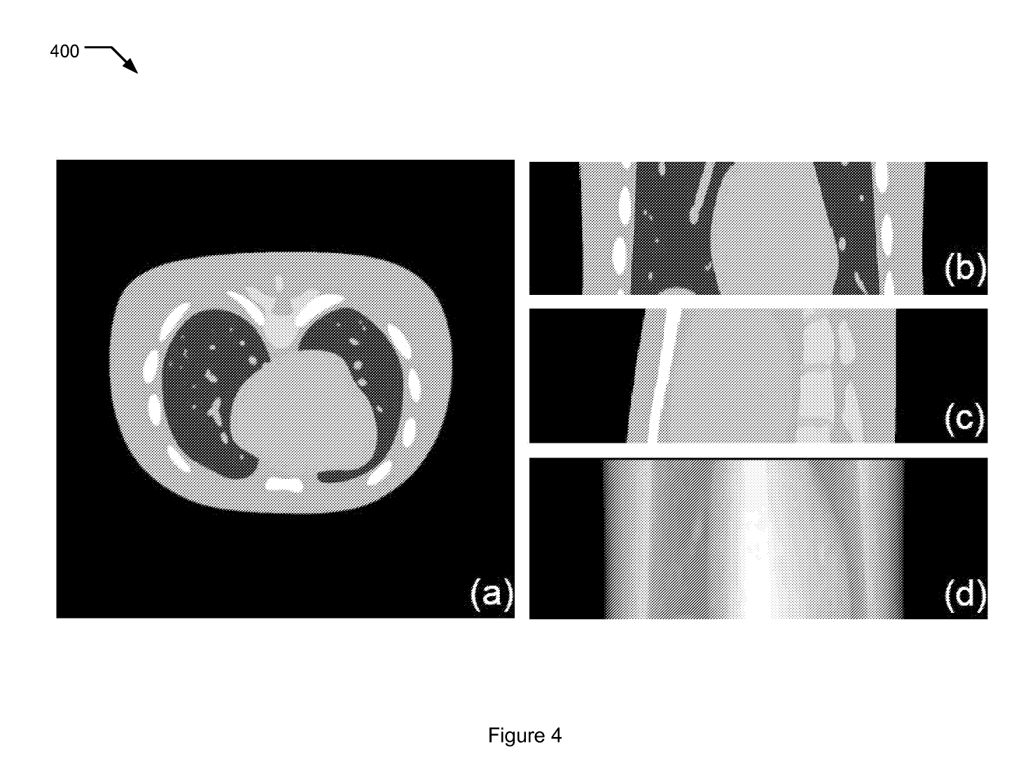

Also, for the example shown in FIG. 4, the phantom is generated at thorax region with a size of 512×512×70 voxels and the x-ray imager is modeled to be an array of 512×384. The source to axes distance is 100 cm and the source to detector distance is 150 cm. X-ray projections are computed along various directions with Siddon's ray tracing algorithm. Specifically, FIG. 4 shows three slice cuts 400 of an NCAT phantom used in CBCT reconstruction as well as a typical x-ray projection along the AP direction. Panel (a) shows the NCAT phantom used in CBCT reconstruction is shown in axial view. Panel (b) shows the coronal view, and panel (c) shows the sagittal view. One x-ray projection along the AP direction is also shown in panel (d).

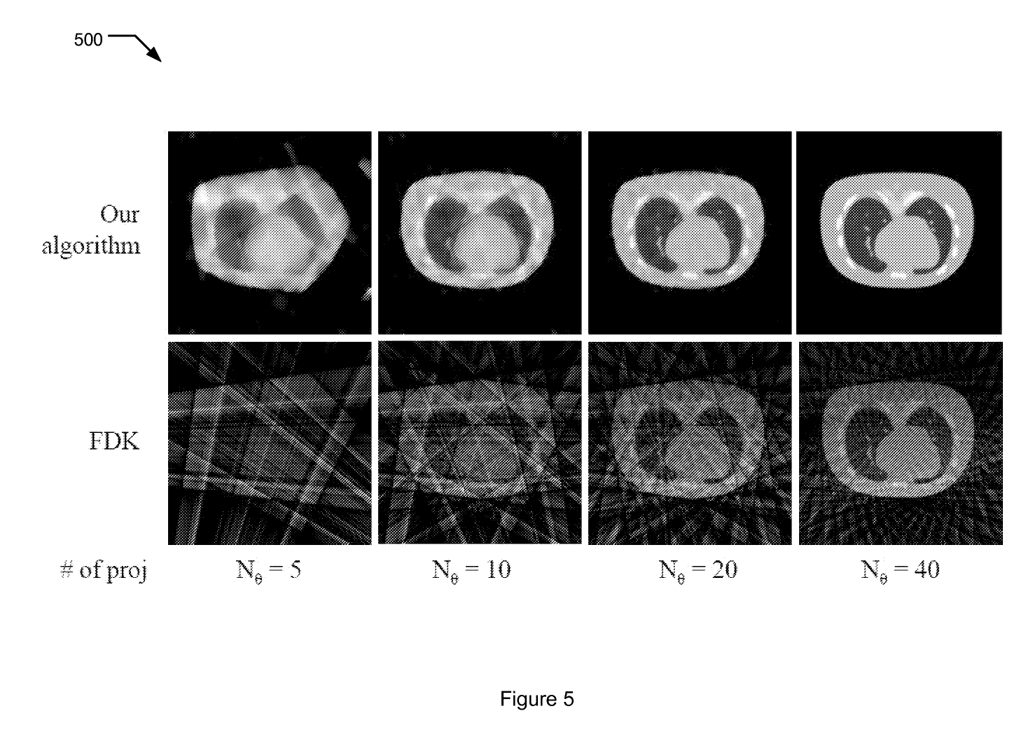

The CBCT images are first reconstructed based on different number of x-ray projections N_{θ}. In all cases, the projections can be taken along equally spaced angles covering an entire 360 degree rotation. FIG. 5 shows an axial view 500 of the reconstructed CBCT image under N_{θ}=5, 10, 20, and 40 x-ray projections. The top row is obtained from the described CBCT algorithm, while the bottom row is from the FDK algorithm.

For the purpose of comparison, the images reconstructed from conventional FDK algorithm is shown with same experimental setting. The reconstructed CBCT image from the described CBCT method based on 40 projections is almost visually indistinguishable from the ground-truth. On the other hand, the image produced by the conventional FDK algorithm is full of streak artifacts due to the insufficient number of projections. Moreover, the required number of projections can be further lowered for some clinical applications. For example, 20 projections may suffice for patient setup purposes in radiotherapy, where major anatomical features have already been retrieved. As far as radiation dose is concerned, the results shown in FIG. 5 indicate a 9 times or more dose reduction compared with the currently widely used FDK algorithm, where about 360 projections are usually taken in a full-fan head-and-neck scanning protocol.

In order to quantify the reconstruction accuracy, the correlation coefficient c≡corr(ƒ,ƒ_{O}) and the relative error

$$e ≡ \frac{{‖ f - {f}_{o} ‖}_{2}}{{‖ {f}_{o} ‖}_{2}}$$

as metrics to measure the closeness between the ground truth image ƒₒ(x,y,z) and the reconstruction results ƒ(x,y,z). The relative error e and the correlation coefficient c corresponding to the results shown in FIG. 5 are summarized in Table 1. The more projections used, the better reconstruction quality is obtained, leading to a smaller relative error e and a higher correlation coefficient c. In addition, the total reconstruction time is short enough for real clinical applications. As shown in Table 1, the reconstructions can be accomplished within 77˜30 seconds on a NVIDIA Tesla C1060 GPU card, when 20˜40 projections are used. Compared with the computational time of several hours in other reconstruction approaches, the described CBCT algorithm has achieved a tremendous efficiency enhancement (˜100 times speed up).

TABLE 1

| | Error | Correlation | Computation |
|---|---|---|---|
| N_{θ} | e (%) | C | Time t (sec) |
| 5 | 28.63 | 0.9386 | 38.7 |
| 10 | 15.96 | 0.9813 | 51.2 |
| 20 | 11.38 | 0.9906 | 77.8 |
| 40 | 7.10 | 0.9963 | 130.3 |

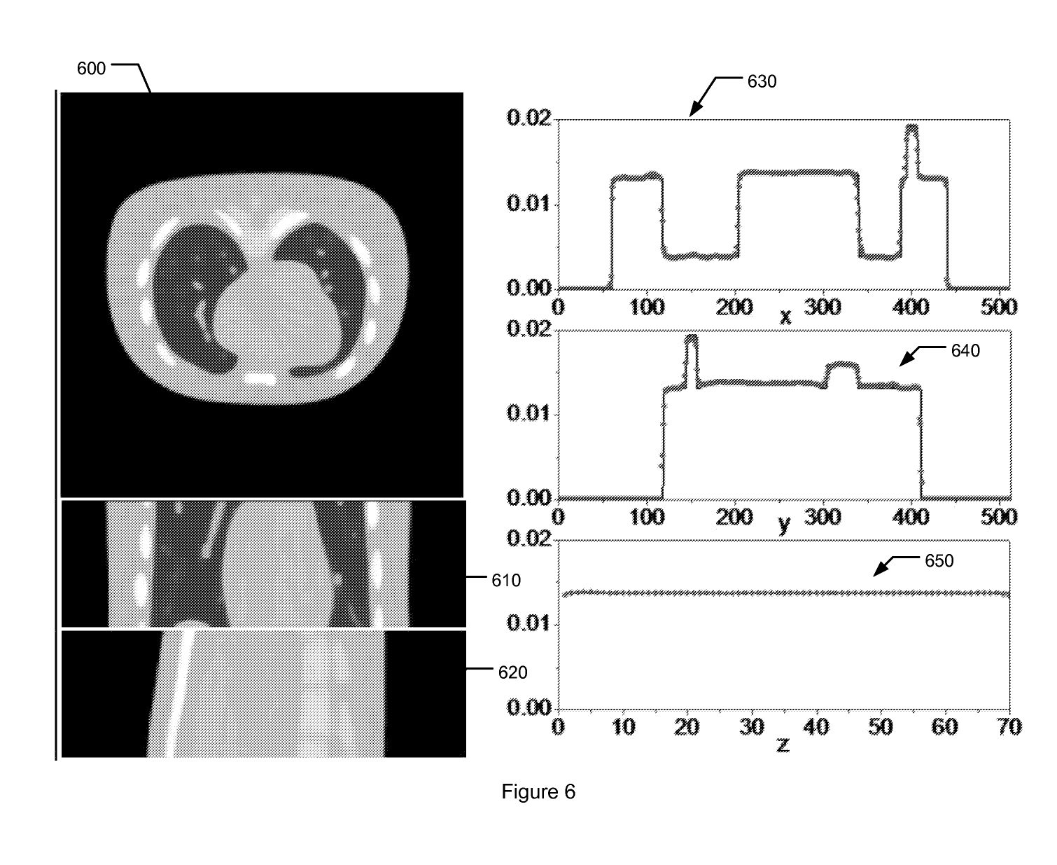

To have a complete visualization of the reconstructed CBCT image, FIG. 6 shows three orthogonal planes 600, 610 and 620 of the final reconstructed image with N_{θ}=40 projections on the left column. From top to bottom are axial, coronal, and sagittal view. Also, the right column shows image profiles 630, 640 and 650 plotted along the central lines in x, y, and z directions (see closed circles) to have a clear comparison between the reconstructed images and the ground truth. The corresponding profiles in the ground-truth image are indicated by solid lines. These plots show that the reconstructed image, though containing small fluctuations, is close to the ground-truth data to a satisfactory extent.

The following describes the convergence of the described algorithm for this NCAT phantom case, as the ground truth is known here and the quality of the reconstructed image can be quantified. The rigorous proof of the convergence of A1 has been established mathematically. Therefore, whether the solution to Eq. (2) above is reached, or if not, how far away from it, could be only an issue of the number of iteration steps. Since the solution to Eq. (2) is not known (note that this solution is different from the ground truth image), it can be hard to quantify how far away the solution obtained in our algorithm is from the true solution. Alternatively, the relative error can be used to measure the distance between the described solution and the ground truth. Though this is not the mathematically correct metric to measure the convergence toward the true solution to Eq. (2), it is a practically relevant metric to quantify the goodness or correctness of the algorithm. In the described algorithm, the relative error and the obtained image quality are acceptable, when the iteration is terminated.

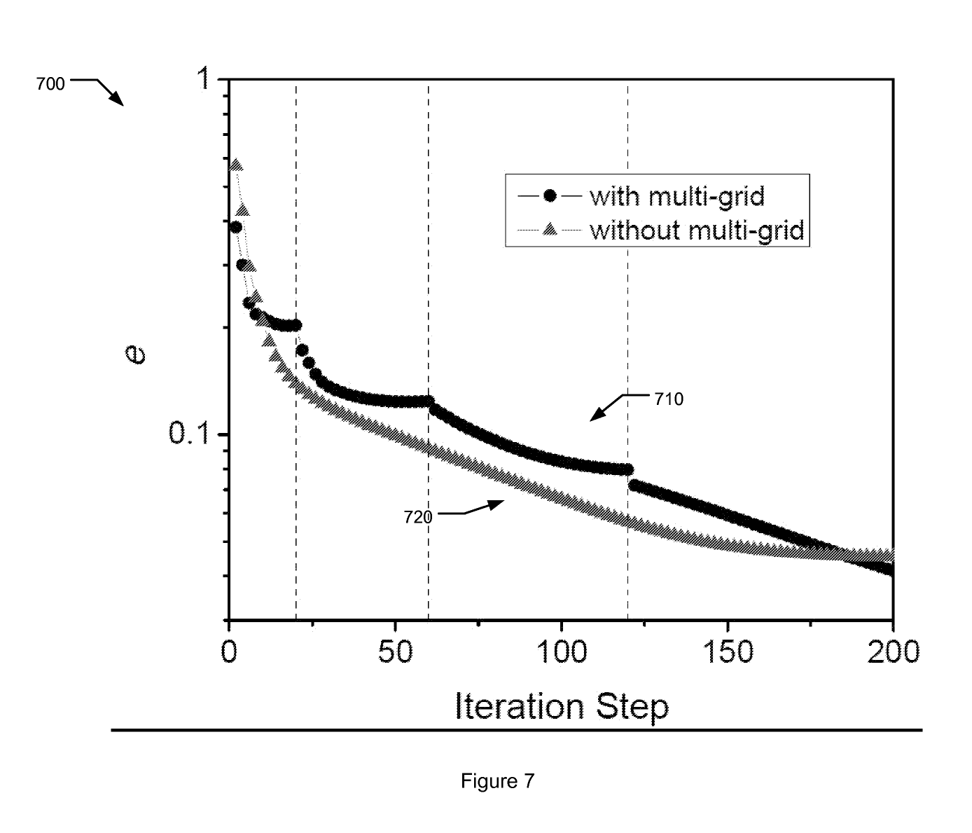

To further demonstrate the convergence process, N_{θ}=40 can be used as an example. FIG. 7 shows a plot 700 of relative error e as a function of iteration step with (circles 710) and without (triangles 720) using the multi-grid technique. The vertical dash lines indicate the places where the transitions from one multi-grid level to the next are taking place. The number of iterations on each multi-grid level is 20, 40, 60, and 80 from the coarsest to the finest grid, respectively. For the purpose of comparison, the evolution of the error e is also plotted when only the finest grid level is used. When the total 200 iteration steps are finished, the iterations with and without multi-grid method achieve similar level of e. However, computation-wise, the one with multi-grid method is more favorable, as a large fraction of total iteration steps are performed at coarse grids, where the computation load is much less than that on the finest grid level. The computation time with multi-grid is approximately half of that without it.

### Calphan Phantom

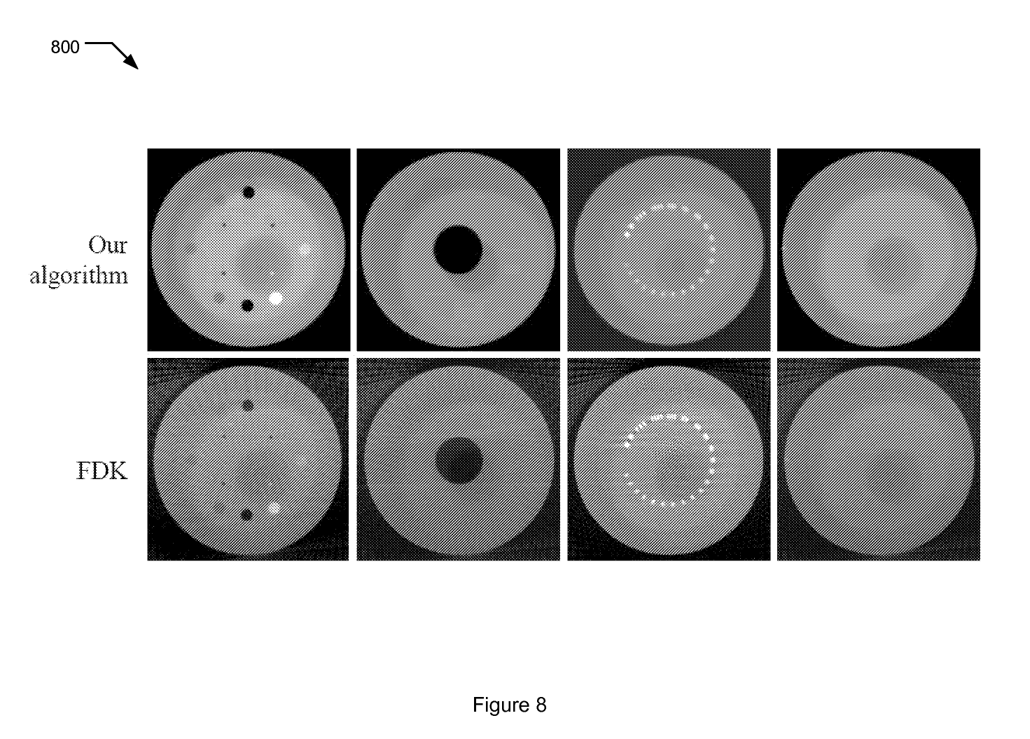

To demonstrate the described algorithm's performance in a real physical phantom, CBCT reconstruction can be performed on a CatPhan 600 phantom (The Phantom Laboratory, Inc., Salem, NY). Multiple projections (e.g., 379) within multiple (e.g., 200) degrees are acquired using a Varian On-Board Imager system (Varian Medical Systems, Palo Alto, Calif.) at 2.56 mAs/projection under a full-fan mode. A subset of equally spaced 40 projections is used to perform the reconstruction. FIG. 8 shows axial views of the reconstructed images 800 of a CatPhan phantom from N_{θ}=40 projections at four axial slices based on the described method (top row) and the FDK method (bottom row) at 2.56 mAs/projection. Different columns correspond to different layers at the phantom. The images obtained from the described method are smooth and major features of the phantom are captured. On the other hand, the FDK algorithm leads to images contaminated by serious streaking artifacts.

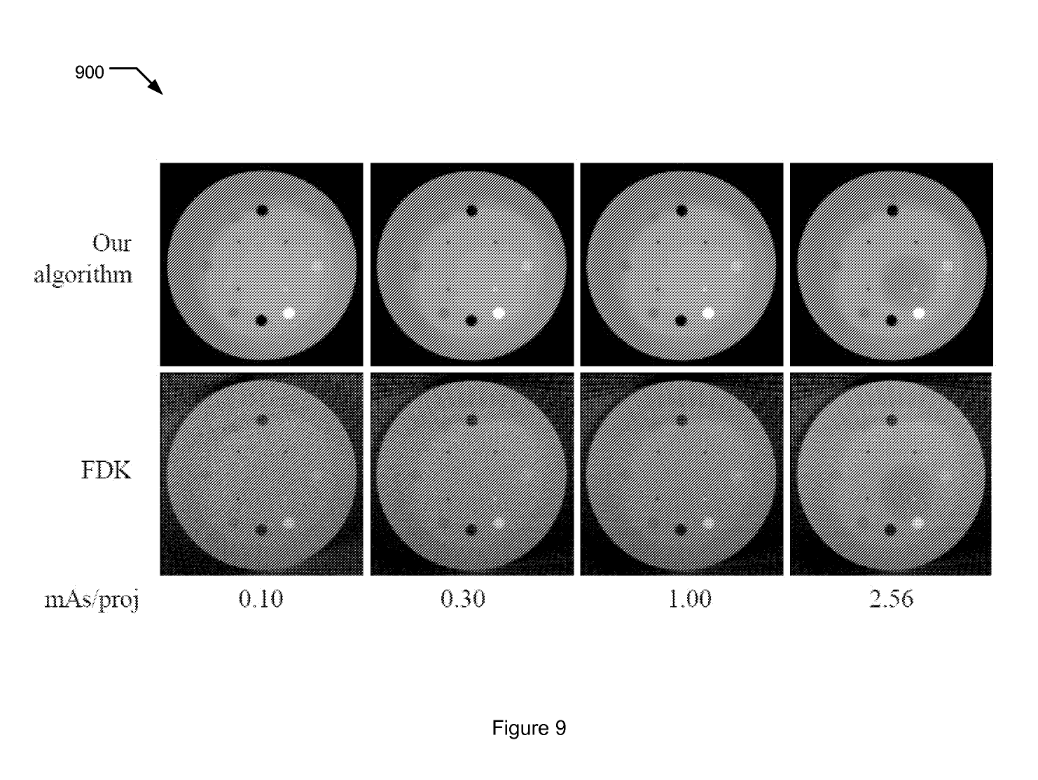

To further test the capability of handling noisy data, CBCT scans can be performed under different mAs levels and reconstructions can be then conducted using the described TV-based algorithm and the FDK algorithm, as shown FIG. 9. Specifically, FIG. 9 shows an axial view 900 of the reconstructed CBCT images of a CatPhan phantom at various mAs levels (0.10, 0.30, 1.00 and 2.56) for N_{θ}=40 projections. Again, the images produced by the described method are smooth and free of streaking artifacts, and thus outperforming those from the FDK algorithm. In particular, under an extremely low mAs level of 0.1 mAs/projection, the described method is still able to capture major features of the phantom. Compared with the currently widely used full-fan head-and-neck scan protocol of 0.4 mAs/projection, this performance may indicate a dose reduction by a factor of ˜4 due to lowering the mAs level. Taking into account the dose reduction by reducing the number of x-ray projections, an overall 36 times dose reduction can be achieved.

### Head-and-Neck Case

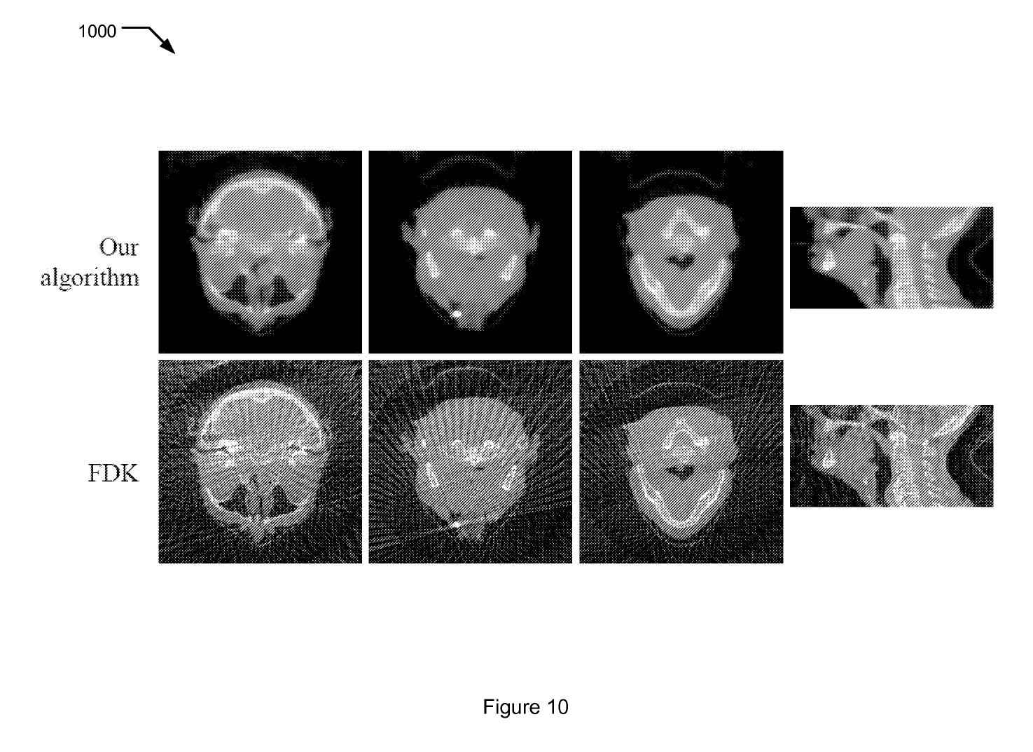

Also, the described CBCT reconstruction algorithm can be validated on realistic head-and-neck anatomic geometry. A patient head-and-neck CBCT scan can be obtained using a Varian On-Board Imager system with 363 projections in 200 degrees and 0.4 mAs/projection. A subset of only 40 projections is selected for the reconstruction in this example. FIG. 10 shows the results in this case from our algorithm as well as from the convential FDK algorithm. Specifically, FIG. 10 shows reconstructed CBCT images 1000 of a patient from N_{θ}=40 x-ray projections based on the described algorithm (top row) and the FDK algorithm (bottom row). The first three columns correspond to axial views at different layers and the last column is the sagittal view. Due to the complicated geometry and high contrast between bony structures and soft tissues in this head-and-neck region, streak artifacts are extremely severe in the images obtained from FDK algorithm under the undersampling case. In contrast, the described algorithm successfully leads to decent CBCT image quality, where artifacts are hardly observed and high image contrast is maintained. For example, when a metal dental filling exists in the patient, the described algorithm can still capture it with high contrast, whereas the FDK algorithm produces a number of streaks in the CBCT image.

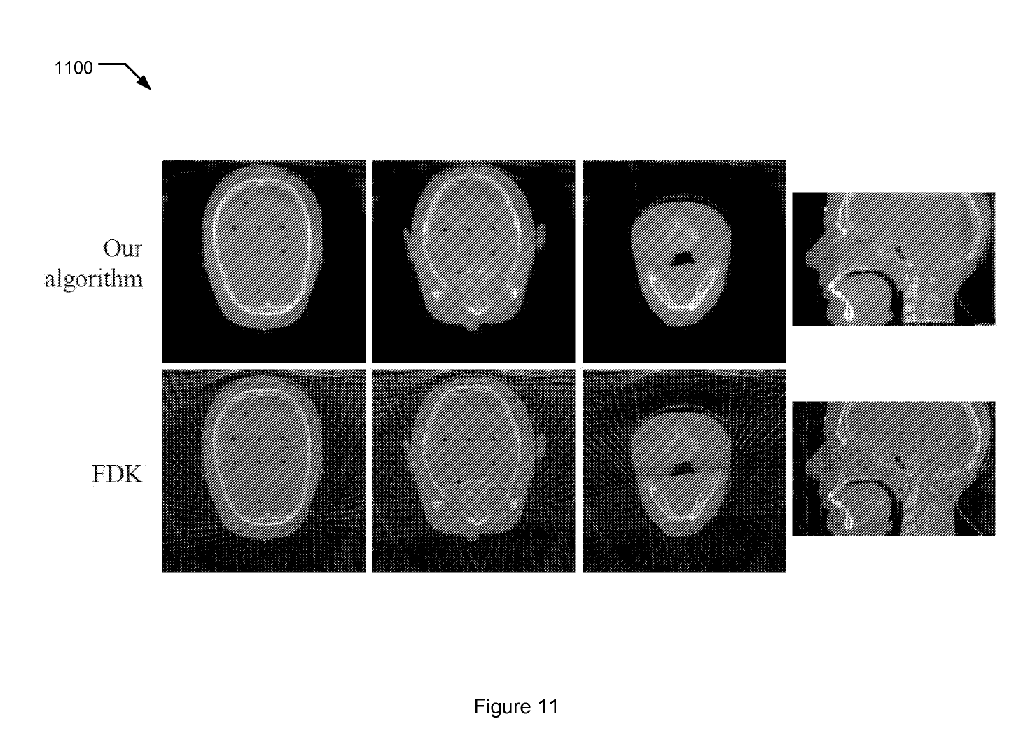

In addition, CBCT scans can be performed on an anthropomorphic skeleton Rando head phantom (The Phantom Laboratory, Inc., Salem, N.Y.) to validate the described algorithm under low mAs levels in such a complicated anatomy. 363 projections within 200 degrees are acquired using a Varian On-Board Imager system at various mAs/projection levels. The CBCT reconstruction uses only a subset of equally spaced 40 projections. In FIG. 11, the reconstruction results (1100) of this phantom under 0.4 mAs/projection is shown, which is the current standard scanning protocol for head-and-neck patients. In particular, FIG. 11 shows reconstructed images (1100) of a Rando head phantom from N_{θ}=40 x-ray projections based on the described method (top row) and the FDK method (bottom row). These results are presented in an axial view at three different slices (first three columns) as well as in a segittal view (last column). The horizontal dark lines in the segittal view are separations between neighboring slice sections of the phantom.

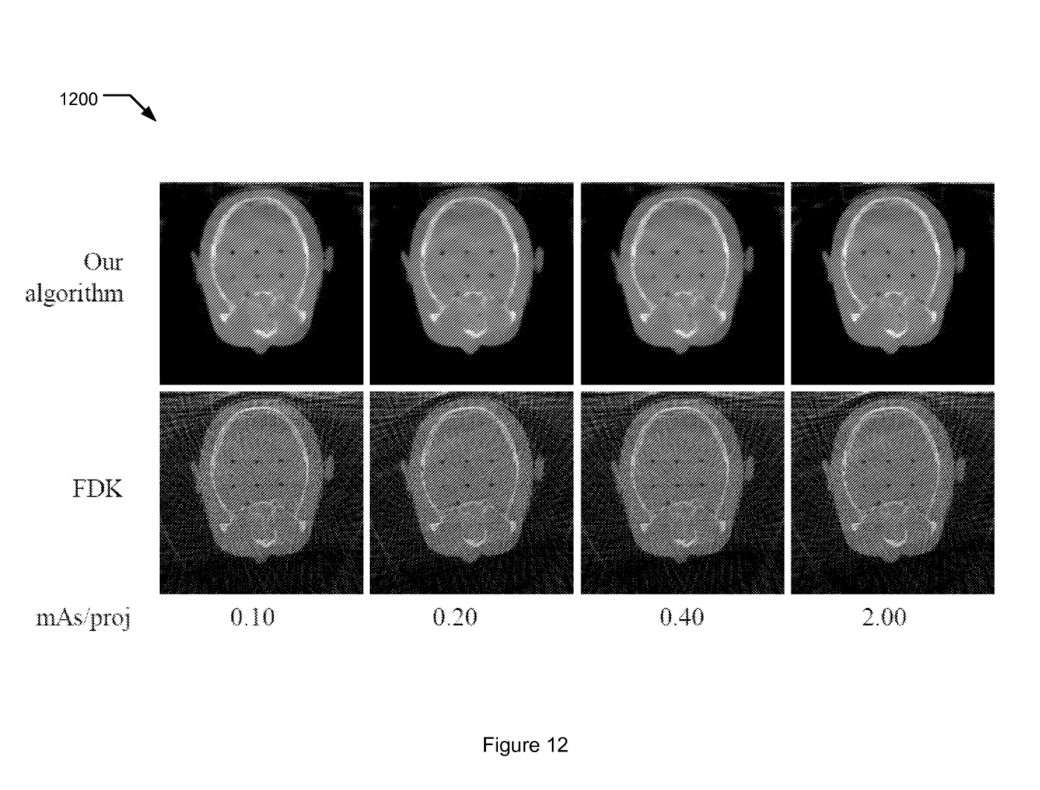

In addition, FIG. 12 shows CBCT reconstruction results (1200) represented under different mAs levels ranging from 0.1 mAs/projection to 2.0 mAs/projection. Specifically, FIG. 11 shows an axial view of the reconstructed CBCT images (1200) of a head phantom at various mAs levels for N_{θ}=40 projections. In all of these testing cases, the described method can reconstruct high quality CBCT images, even under low mAs levels at low number of projections. This demonstrates the advantages of the describe algorithm over the conventional FDK algorithm. As far as the dose reduction, a factor of 36 can be achieved in this head-and-neck example.

### Tangible Useful Applications of TV-Based CBCT Reconstruction

Only a few embodiments has be described for a fast iterative algorithm for CBCT reconstruction. In the described TV-Based CBCT techniques, an energy functional that includes a data fidelity term and a regularization term of TV semi-norm can be used. The minimization problem can be solved with a GPU-friendly forward-backward splitting method together with a multi-grid approach on a GPU platform, leading to both satisfactory accuracy and efficiency.

Reconstructions performed on a digital NCAT phantom and a real patient at the head-and-neck region indicate that images with decent quality can be reconstructed from 40 x-ray projections in about 130 seconds. Also, the described algorithm has been tested on a CatPhan 600 phantom and Rando head phantom under different mAs levels and found that CBCT images can be successfully reconstructed from scans with as low as 0.1 mAs/projection. All of these results indicate that the described new algorithm has improved the efficiency by a factor of −100 over existing similar iterative algorithms and reduced imaging dose by a factor of at least 36 compared to the current clinical standard full-fan head and neck scanning protocol. The high computation efficiency achieved in the described algorithm makes the iterative CBCT reconstruction approach applicable in real clinical environments.

### TF-Based CBCT Reconstruction Algorithm

In another aspect, a fast GPU-based algorithm can be implemented to reconstruct high quality CBCT images from undersampled and noisy projection data so as to lower the imaging dose. In particular, described is an iterative tight frame (TF) based CBCT reconstruction algorithm. A condition that a real CBCT image has a sparse representation under a TF basis is imposed in the iteration process as regularization to the solution. To speed up the computation, a multi-grid method is employed. The described GPU implementation can achieve high computational efficiency and a CBCT image of resolution 512×512×70 can be reconstructed in about ˜139 sec. The described algorithm can be implemented on a digital NCAT phantom and a physical Calphan phantom. The described TF-based algorithm can be used to reconstrct CBCT in the context of undersampling and low mAs levels. Also, the reconstructed CBCT image quality can be quantitatively analyzed in terms of modulation-transfer-function and contrast-to-noise ratio under various scanning conditions. The results confirm the high CBCT image quality obtained from the described TF algorithm. Moreover, the described algorithm has also been validated in a real clinical context using a head-and-neck patient case.

Tight frames have the same structure as the traditional wavelets, except that they are redundant systems that generally provide sparser representations to piecewise smooth functions than traditional wavelets. CBCT reconstruction problem can be generally viewed as a 3-dimensional image restoration problem. In such a problem, the discontinuities of the reconstructed piecewise smooth image provide very important information, as they usually account for the boundaries between different objects in the volumetric image. In the TF approach, one tries to restore TF coefficients of the image, which usually correspond to important features, e.g. edges, as opposed to the image itself. This allows us to specifically focus on the reconstruction of the important information of the image, hence leading to high quality reconstruction results.

Besides its effectiveness, TF approach also has attractive numerical properties. Numerical schemes specifically designed for the TF approach can lead to a high convergence rate. Also, the numerical scheme only involves simple matrix-vector or vector operations, making it straightforward to implement the algorithm and parallelize it in a parallel computing structure. It is these numerical properties that lead to high computational efficiency in practice. Moreover, general purpose graphic processing units (GPUs) have offered a promising prospect of increasing efficiencies of heavy duty tasks in radiotherapy, such as CBCT FDK reconstruction, deformable image registration, dose calculation, and treatment plan optimization. Taking advantages of the high computing power of the GPU, the computation efficiency of TF-based CBCT reconstruction can be enhanced considerably.

Techniques, system and apparatus are described for implementing a novel CBCT reconstruction algorithm based on TF and implemented it on a GPU. The described techniques, systems and apparatus can provide a new approach for CBCT reconstruction, in addition to the well known FDK-type algorithms and the state-of-the-art iterative reconstruction algorithms, such as total variation. The described techniques, along with some validations, are described below. Experiments on a digital phantom, a physical phantom, and a real patient case demonstrate the possibility of reconstructing high quality CBCT images from extremely under sampled and noisy data. The associated high computational efficiency due to the good numerical property of the TF algorithm and our GPU implementation makes this approach practically attractive. By introducing the novel TF algorithm to the CBCT reconstruction context for the first time, can shed a light to the CBCT reconstruction field and contribute to the realization of low dose CBCT.

### TF Model and Algorithm

For a patient volumetric image represented by a function ƒ(x) with x=(x,y,z)εR³. A projection operator P^{θ} maps ƒ(x) into another function on an x-ray imager plane along a projection angle θ.

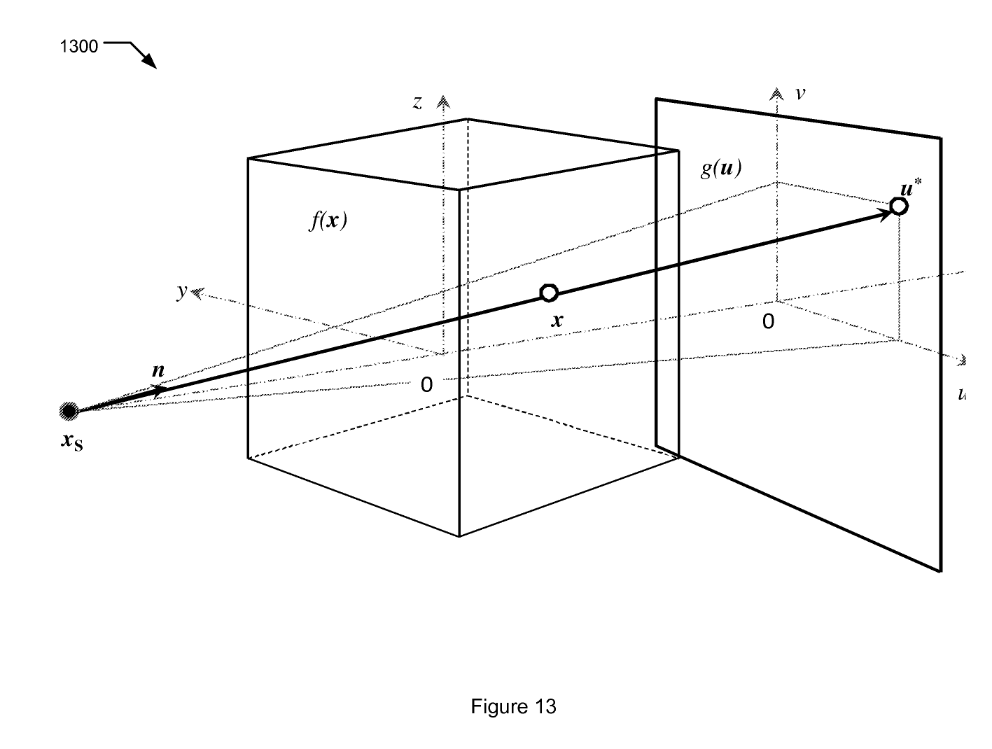

P^{θ}[ƒ](μ)≡˜∫₀^{L(u)}dlƒ(xₛ−nl), (13)

where xₛ=(xₛ,x_{y},zₛ) is the coordinate of the x-ray source and u=(u,v)εR² is the coordinate of the projection point on the x-ray imager, n=(n₁,n₂,n₃) being a unit vector along the projection direction. FIG. 13 illustrates the geometry 1300 of x-ray projection. The operator P^{θ} maps ƒ(x) in R³ onto another function P^{θ}[ƒ](u)) in R², the x-ray imager plane, along a projection angle θ. L(u) is the length from xₛ to u* and l(x) is that from xₛ to x. The source to imager distance is Lₒ. The upper integration limit L(u) is the length of the x-ray line. Denote the observed projection image at the angle θ by g^{θ}(u). Mathematically speaking, a CBCT reconstruction problem is formulated as to retrieve the volumetric image function ƒ(x) based on the observation of g^{θ}(u) at various angles given the projection mapping in equation (13).

The CBCT image reconstruction from few projections is an underdetermined problem. Because of insufficient measurements made at only a few x-ray projections, there are indeed infinitely many functions f satisfying the condition P^{θ}[ƒ](u)=g^{θ}(u). Therefore, regularization based on some assumptions about the solution f has to be performed during the reconstruction process. These regularization-based CBCT reconstruction approaches usually result in solving challenging minimization problems. The most commonly used approach is an alternative iteration scheme, where, within each iteration step, conditions to be satisfied by the solution is imposed one after another. In the described problem, there are three conditions that need to be satisfied by the solution, and three key operations are performed in each iteration step accordingly. These conditions, as well as the operations ensuring them, are described in the following.

First, the x-ray projection of the reconstructed volumetric image ƒ(x) should match the observation g^{θ}(u). This condition is commonly achieved by solving a linear system Pƒ=g, where P is the matrix representation of the projection operator P^{θ}, and ƒ and g are vectors corresponding to the solution ƒ(x) and the observation g^{θ}(u), respectively. Nonetheless, since this is a highly underdetermined problem, any numerical scheme tending to directly solve Pƒ=g is unstable. Instead, in this aspect of the specification, described is an implementation of a minimization of an energy E[ƒ]=∥Pƒ−g∥₂² by using a conjugate gradient least square (CGLS) algorithm. This algorithm is essentially an iterative algorithm, which generates a new solution ƒ given an initial guess v. This process can be represented as ƒ←CGLS[v], and the details regarding the implementation of the CGLS algorithm are described below. The CGLS algorithm can be used to efficiently solve this minimization problem, and hence ensure the consistency between the reconstructed volumetric image ƒ(x) and the observation g^{θ}(u).

Second, a regularization condition can be imposed to the solution ƒ(x) that it has a sparse representation under a piecewise linear TF system X={ψᵢ(x)}. The solution ƒ(x) can be decomposed by X into a set of coefficient as αᵢ(x)=ψᵢ(x) [symbol] ƒ(x), where [symbol] stands for the convolution of two functions. In this specification, the piece-wise linear TF basis is used. Specifically, in one-dimension (1D), the discrete forms of the basis functions are chosen as

$${h}_{o} = \frac{1}{4 [ 1 , 2 , 1 ]} , {h}_{1} = \frac{\sqrt{2}}{4 [ 1 , 0 , - 1 ]} ,$$

and

$${h}_{2} = \frac{1}{4 [ - 1 , 2 , - 1 ]} .$$

The 3D basis functions are then constructed by the tenser product of the three 1D basis functions, i.e., ψᵢ(x,y,z)=hₗ(x)hₘ(y)hₙ(z), with integers l, m, n chosen from 0, 1, or 2. The transform from ƒ(x) to the TF coefficient αᵢ(x) via convolution is a linear operation. To simplify the notation, this transformation can be represented in a matrix notation as α=Dƒ, where α is a vector consisting of all the TF coefficients. The introduction of the matrix D is merely for the purpose of simplifying notation. In practice, this transformation can be computed via convolution but not matrix multiplication. Conversely, the function ƒ(x) can be uniquely determined given a set of coefficients {αᵢ(x)} by

$$f ( x ) = {\sum }_{i} {ψ}_{i} ( - x ) ⊗ {α}_{i} ( x ) ,$$

which can be denoted as ƒ=D^{T}α.

Many natural images have a very sparse representation under the TF system X, i.e. there are only a small proportion of the elements within the coefficient vector α that are considerably larger in magnitude than the rest of the elements. It is this property that can be utilized a priori as a regularization term in our CBCT reconstruction problem. A common way of imposing this condition into the solution ƒ is to throw away small TF coefficients. The deletion of these small coefficients not only sharpens edges but also removes noises in the reconstructed CBCT. As such, ƒ can be decomposed into the TF space; then soft-threshold the TF coefficients with a predetermined value μ; and finally reconstruct ƒ based on the new coefficients. This process can be denoted as ƒ←D^{T} [symbol] Dƒ. Here the soft-threshold operation is defined as:

$${𝒯}_{μ} α = \{ \begin{matrix}sgn ( α ) ( \vert α \vert - μ ) \text{:} & if \vert α \vert > μ \\ 0 \text{:} & if \vert α \vert < μ ,\end{matrix} \qquad ( 14 )$$

where sgn(.) is sign function defined as

$$sgn ( α ) = \{ \begin{matrix}1 \text{:} & if α > 0 \\ 0 \text{:} & if α = 0 \\ - 1 \text{:} & if α < 0.\end{matrix} \qquad ( 15 )$$

It is understood that the soft-threshold operation [symbol] α is performed component-wise on the vector α.

Third, since the reconstructed CBCT image ƒ(x) physically represents x-ray attenuation coefficient at a spatial point x, its positivity has to be ensured during the reconstruction in order to obtain a physically correct solution. For this purpose, a correction step of the reconstructed image ƒ(x) is performed by setting its negative voxel values to be zero. Mathematically, this operation is denoted by ƒ← [symbol] ƒ, where the operation [symbol] stands for a voxel-wise truncation of the negative values in the CBCT image ƒ.

In considering all the components mentioned above, the reconstruction algorithm can be summarized as shown in Algorithm B1:

Algorithm B1:

Initialize: f⁽⁰⁾=0.
For k = 0, 1, . . . do the following steps until convergence

1. Update: f^{(k+1)}=CGLS[f^{(k)}];
2. Shrinkage: f^{(k+1)} ← D^{T} [symbol] _{μ}Df^{(k+1)};
3. Correct: f^{(k+1)} ← [symbol] f^{(k+1)}.

There is only one tuning parameter μ in the algorithm. In practice, its value is carefully tuned so that the best image quality can be obtained. An example of a process for selecting this parameter is described further below.

Mathematically, the TF coefficients Dƒ^{(k)} generated by Algorithm B1 can be shown to converge to the following optimization problem:

$${arg min}_{α} \frac{1}{2} {‖ {PD}^{T} α - g ‖}_{2}^{2} + \frac{1}{2} {‖ ( 1 - {DD}^{T} ) α ‖}_{2}^{2} + μ {‖ α ‖}_{1} , \\ s . t . {D}^{T} α \geq 0. \qquad ( 16 )$$

The optimization problem of Equation (16) is a successful model in solving image restoration problems. With a simple modification, the convergence rate of B1 can be considerably enhanced, leading to Algorithm B2 used in the described reconstruction problem:

Algorithm B2:

```
Initialize: f⁽⁰⁾ = f⁽⁻¹⁾ = 0, t⁽⁰⁾ = t⁽⁻¹⁾ = 1.0,
For k = 0, 1, . . . do the following steps until convergence
  $1. Compute \text{:} {v}^{( k )} ← {f}^{( k )} + \frac{{t}^{( k - 1 )} - 1}{{t}^{( k )} [ {f}^{( k )} - {f}^{( k - 1 )} ]} ;$
  2. Update: f^{(k+1)} = CGLS[v^{(k)}];
  3. Shrinkage: f^{(k+1)} ← D^{T}T_{μ}Df^{(k+1)};
  4. Correct: f^{(k+1)} ← Hf^{(k+1)};
  $5. Set \text{:} {t}^{( k + 1 )} = \frac{1}{2} [ 1 + \sqrt{1 + 4 {t}^{{( k )}^{2}}} ] .$
```

### TF-Based CBCT Implementation

The CBCT reconstruction problem can be solved with the aforementioned algorithm B2 on a GPU, such as an NVIDIA Tesla C1060 card. This GPU card has a total number of 240 processor cores (grouped into 30 multiprocessors with 8 cores each), each with a clock speed of 1.3 GHz. It is also equipped with 4 GB DDR3 memory, shared by all processor cores. Utilizing such a GPU card with tremendous parallel computing ability can considerably elevate the computation efficiency. Described below are components of the described implementation.

### GPU Parallelization

In fact, a number of computationally intensive tasks involved in algorithm B2 share a common feature, i.e. applying a single operation to different part of data elements. For computation tasks of this type, it is straightforward to accomplish them in a data-parallel fashion, namely having all GPU threads running the same operation, one for a given subset of the data. Such a parallel manner is particularly suitable for the SIMD (single instruction multiple data) structure of a GPU and high computation efficiency can be therefore achieved.

Specifically, the following components in B2 fall into this category: 1) The component-wise soft-threshold in Step 3 and the voxel-wise positivity correction of the CBCT image in Step 4 can be parallelized with one GPU thread responsible for one TF coefficient or one voxel, respectively. 2) The transformation of a CBCT image f into the TF space can be merely a convolution operation αᵢ(x)=ψᵢ(x) [symbol] ƒ(x). This computation can be performed by having one GPU thread compute the resulted αᵢ(x) at one x coordinate. The inverse transformation from the TF coefficient α to the image ƒ is also a convolution operation and can be achieved in a similar manner. 3) A matrix vector multiplication of the form g=Pf is frequently used in the CGLS method. This operation corresponds to the forward x-ray projection of a volumetric image ƒ(x) to the imager planes, also known as a digital reconstructed radiograph. In the described implementation, it is performed in a parallel fashion, with each GPU thread responsible for the line integral of equation (13) along an x-ray line using Siddon's ray-tracing algorithm.

### CGLS Method

Another distinctive component in the described implementation is the CGLS solution to the optimization problem

$${min}_{f} {‖ Pf - g ‖}_{2}^{2}$$

in step 2 of B2. in this step, a CGLS method is applied to efficiently find a solution ƒ^{(k+}1) to this least square problem with an initial value of v^{(k)} in an iterative manner. The details of this CGLS algorithm are provided below in a step-by-step manner.

CGLS algorithm can be used to solve the least-square problem

$${min}_{x} {‖ Px - y ‖}_{2}^{2}$$

in an iterative manner using conjugate gradient method. Specifically, the algorithm performs following iterations:

Algorithm CGLS:

```
Initialize: x⁽⁰⁾; r⁽⁰⁾ = y = Px⁽⁰⁾; p⁽⁰⁾ = s⁽⁰⁾ = P^{T}r⁽⁰⁾; γ⁽⁰⁾ = ∥s⁽⁰⁾∥₂²;
For l = 0, 1, . . . , M, do the following steps
  1. q^{(l)} = Pp^{(l)}
  $2. {α}^{( l )} = \frac{{γ}^{( l )}}{{‖ {q}^{( l )} ‖}_{2}^{2}} ;$
  3. x^{(l+1)} = x^{(l)} + α^{(l)}p^{(l)}, r^{(l+1)} = r^{(l)} − α^{(l)}q^{(l)};
  4. s^{(l+1)} = P^{T}r^{(l+1)};
  5. γ^{(l+1)} = ∥s^{(l+1)}∥₂²;
  $6. {β}^{( l )} = \frac{{γ}^{( l + 1 )}}{{γ}^{( l )}} ;$
  7. p^{(l+1)} = s^{(l+1)} + β^{(l)}p^{(l)}.
Output x^{(M+1)} as the solution.
```

In the context of CBCT reconstruction with only a few projections, the normal equation P^{T}Px=P^{T} y is indeed underdetermined. The convergence of the CGLS algorithm for underdetermined problems has been defined. In the described reconstruction algorithm, the CGLS is used as a means to ensure the data fidelity condition during each iteration step of the reconstruction. Specifically, given an input image x⁽⁰⁾=ƒ, the CGLS algorithm outputs a solution ƒ′=x^{(m+1)} which is better than the input in the sense that the residual ∥Pƒ′−∥₂² is smaller than ∥Pƒ−y∥₂². This fact always holds regardless the singularity of the linear system.

Since the use of CGLS is merely for ensuring data fidelity via minimizing the residual l₂ norm, in each outer iteration of the described TF algorithm, it is not necessary to perform CGLS iteration till converge. In practice, M=2˜3 CGLS steps in each outer iteration step is found sufficient. This approach is also favorable in considering the computation efficiency, as more CGLS steps per outer iteration step will considerably slow down the overall efficiency.

Each iteration step of the CGLS algorithm includes a number of fundamental linear algebra operations. For those simple vector-vector operations and scalar-vector operations, CUBLAS package (NVIDIA, 2009) is used for high efficiency. In addition, there are two time-consuming operations needing special attention, namely matrix-vector multiplications of the form g=Pf and f=P^{T}g, where P is the x-ray projection matrix. Though it is straightforward to accomplish g=Pƒ on GPU with the Siddon's ray-tracing algorithm as described previously, it is quite cumbersome to carry out a computation of the form f=P^{T}g. It is estimated that the matrix P, though being a sparse matrix, contains approximately 4×10⁹ non-zero elements for a typical clinical case described herein, occupying about 16 GB memory space. Such a huge matrix P is too large to be stored in a GPU memory, not to mention computing its transpose. Therefore, a new algorithm for completing the task f=P^{T}g has been designed. While ƒ=P^{T}g can be computed using the Siddon's algorithm, such an operation is a backward one in that it maps a function g(u) on the x-ray imager back to a volumetric image ƒ(x) by updating its voxel values along all ray lines. If Siddon's ray-tracing algorithm were still used in the GPU implementation with each thread responsible for updating voxels along a ray line, a memory conflict problem would take place due to the possibility of simultaneously updating a same voxel value by different GPU threads. When this conflict occurs, one thread will have to wait until another thread finishes updating. This severely limits the maximal utilization of GPU's massive parallel computing power.

To overcome this difficulty, the explicit form of the resulting volumetric image function ƒ(x) can be analytically computed when the operator P^{T} acts on a function g(x) on the x-ray imager and a close form expression can be obtained as:

$$f ( x ) = [ {P}^{T} g ] ( x ) = \frac{Δ x Δ y Δ z}{Δ u Δ v} {\sum }_{θ} \frac{{L}^{3} ( {u}^{*} )}{{L}_{0} {l}^{2} ( x )} {g}^{θ} ( {u}^{*} ) . \qquad ( 17 )$$

Here u* is the coordinate for a point on imager where a ray line connecting the x-ray source at xₛ and the point at x intersects with the imager. L₀ is the distance from the x-ray source S to the imager, while I(x) and L(u*) are the distance from xₛ to x and from xₛ to u* on the imager, respectively. Refer back to FIG. 13 for the geometry. Δu and Δv are the pixel size when we descretize the imager during implementation and Δy, Δy, and Δz are the size of a voxel. The derivation of Equation (17) is briefly shown below.

Let ƒ(.): R³→R and g(.): R²→R be two smooth enough functions in the CBCT image domain and in the x-ray projection image domain, respectively. The operator P^{θ}^{^{T}}, being the adjoint operator of the x-ray projection operator P^{θ}, should satisfy the condition

[symbol]

ƒ,P^{θ}^{^{T}} [symbol] = [symbol] P^{θ}ƒ,g [symbol] , (18)

where [symbol] . , . [symbol] denotes the inner product. This condition can be explicitly expressed as

∫dxƒ(x)P^{θ}^{^{T}}[g](x)=∫duP^{∫}[ƒ](u)g(u). (19)

Now take the functional variation with respect to ƒ(x) on both sides of equation (19) and interchange the order of integral and variation on the right hand side. This yields:

$${P}^{{θ}^{T}} [ g ] ( x ) = \frac{δ}{δ f ( x )} \int d u {P}^{θ} [ f ] ( u ) g ( u ) = \int d u g ( u ) \frac{δ}{δ f ( x )} {P}^{θ} [ f ] ( u ) . \qquad ( 20 )$$

With help of a delta function Equation (1) can be rewritten as:

P^{θ}[ƒ](u)=∫dldxƒ(x)δ(x−xₛ−nl). (21)

Substituting Equation (21) into Equation (20), the following can be obtained:

$${P}^{{θ}^{T}} [ g ] ( x ) = \int d l d u g ( u ) δ ( x - {x}_{s} - nl ) = \frac{{L}^{3} ( {u}^{*} )}{{L}_{0} {l}^{2} ( x )} g ( {u}^{*} ) , \qquad ( 22 )$$

Where u* is the coordinate of a point on imager, at which a ray line connecting the source xₛ and the point x intersects with the imager. L(u*) is the length from xₛ to u* and l(x) is the length from xₛ to x. The source to imager distance is L₀. Additionally, a summation over projection angles θ is performed in Equation (16) to account for all the x-ray projection images.

One caveat when implementing Equation (22) is that the equation is derived from condition of Equation (18), where the inner product of two functions is defined in an integral sense. In the CGLS algorithm, both P and P^{T} are viewed as matrices. Therefore, an inner product defined in the vector sense, i.e. [symbol] ƒ, g [symbol] =Σᵢƒᵢgᵢ for two vectors ƒ and g, should be understood in Equation (18). Changing the inner product from a function form to a vector form results in a numerical factor in Equation (16), simply being the ratio of pixel size ΔuΔv to the voxel size ΔzΔyΔz. The accuracy of such defined operator P^{T} in terms of satisfying condition expressed in Equation (18). Numerical experiments indicate that this condition is satisfied with numerical error less than 1%. Though this could lead to CT number inaccuracy in the reconstructed CBCT image, absolution accuracy of CT number is not crucial in the use of CBCT in cancer radiotherapy, since CBCT is mainly used for patient setup purpose. This potential inaccuracy of the Hounsfield Unit should be taken account of when utilizing Equation (17).

Equation (17) indicates a very efficient way of performing ƒ=P^{T}g in a parallel fashion. To compute ƒ(x) at a given x, we simply take the function values of g(u*) at the coordinate u*, multiply by proper prefactors, and finally sum over all projection angles θ. In numerical computation, since g(u) is evaluated at a set of discrete coordinates and u* does not necessarily coincide with these discrete coordinates, a bilinear interpolation is performed to obtain g^{θ}(u*). At this point, the parallel computing can be performed with each GPU thread for a voxel at a given x coordinate. Extremely high efficiency can be obtained given the vast parallelization ability of the GPU.

### Multi-Grid Method

Another technique employed to increase computation efficiency is the multi-grid method. The convergence rate of an iterative approach solving an optimization problem is usually worsened when a very fine grid size Δx, Δy, and Δz is used. Moreover, a fine grid can indicate a large number of unknown variables, significantly increasing the size of the computation task. The multi-grid approach can be utilized to resolve these problems. When reconstructing a volumetric CBCT image ƒ(x) on a fine grid Ωₕ of size h, the process can being with solving the problem on a coarser grid Ω₂ₕ of size Ωₕ with the same iterative approach as in Algorithm B2. Upon convergence, the solution ƒ₂ₕ on Ω₂ₕ, can be smoothly extended to the fine grid Ωₕ using, for example, linear interpolation, and it can be used the initial guess of the solution on Ωₕ. Because of the decent quality of this initial guess, only a few iteration steps of Algorithm B2 are adequate to achieve the final solution on Ωₕ. This idea can be further used while seeking the solution ƒ₂ₕ by going to an even coarser grid of size 4 h. In practice, a 4-level multi-grid scheme can be used, i.e. the reconstruction is sequentially achieved on grids Ω₈ₕ→Ω₄ₕ→Ω₂ₕ→Ωₕ.

### CBCT Reconstruction Results

The CBCT reconstruction results are presented on a NURBS-based cardiac-torso (NCAT) phantom, a Calphan phantom (The Phantom Laboratory, Inc., Salem, N.Y.), and a real patient at head-and-heck region. For the example described, all of the reconstructed CBCT images are of a resolution 512×512×70 voxels with the voxel size chosen as 0.88×0.88×2.5 mm³. The x-ray imager resolution is 512×384 covering an area of 40×30 cm². The reconstructed images are much shorter than the imager dimension along the z-direction due to the cone beam divergence. The x-ray source to axes distance is 100 cm and the source to detector distance is 150 cm. For this example, all of these parameters mimic realistic configurations in a Varian On-Board Imager (OBI) system (Varian Medical Systems, Palo Alto, Calif.). For the cases presented, a total number of 40 x-ray projections are used to perform the reconstruction. For the digital NCAT phantom, x-ray projections are numerically computed along 40 equally spaced projection angles covering a full rotation with Siddon's ray tracing algorithm. As for the Calphan phantom case and the real patient case, they are scanned in the Varian OBI system under a full-fan mode in an angular range of 200°. 363 projections are acquired and a subset of 40 equally spaced projections can be selected for the reconstruction.

NCAT phantom and Calphan phantom

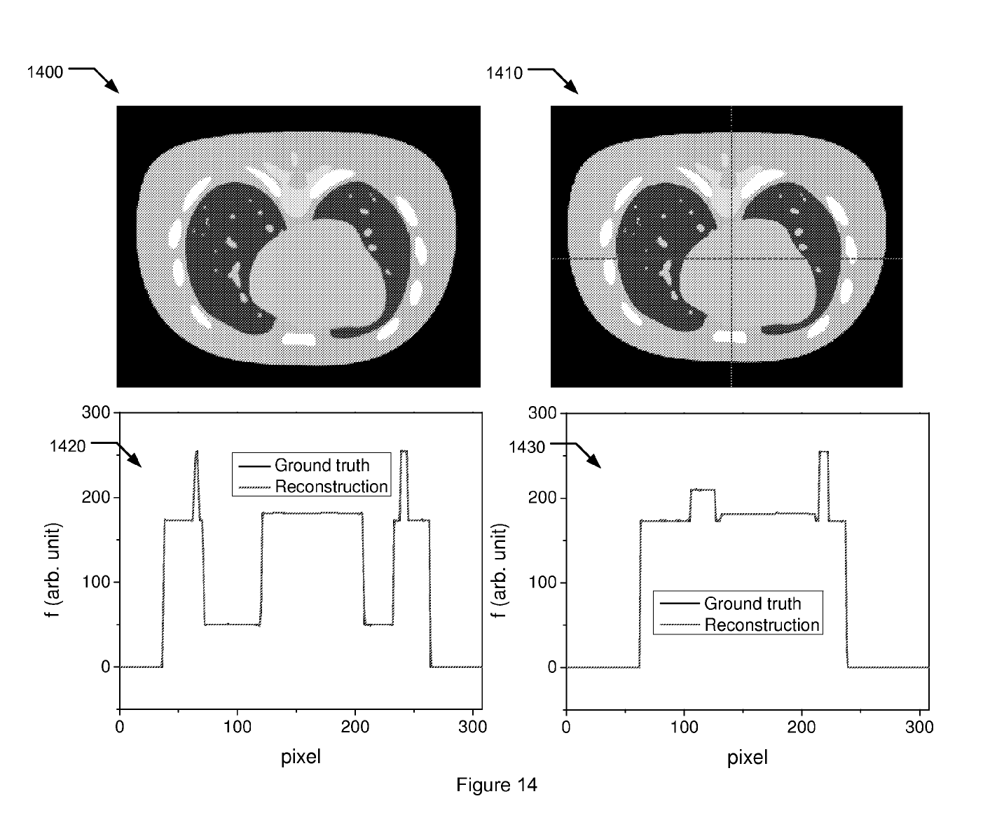

The described TF-based reconstruction algorithm can be tested with a digital NCAT phantom. It is generated at thorax region with a high level of anatomical realism (e.g., detailed bronchial trees). In this simulated case, the projection data are ideal, in that it does not contain contaminations due to noise and scattering as in real scanning. Under this circumstance, a powerful reconstruction algorithm should be able to reconstruct CBCT image almost exactly. For example, the total variation method can yield accurate reconstruction from very few views. To test the TF algorithm, the reconstruction can be first performed with a large number of iterations (˜100 iterations in each multi-grid level) to obtain high image quality. FIG. 14 shows a central slice of a reconstructed CBCT image using the described TF-based algorithm (1400) and the ground truth image (1410); and corresponding comparison of image profiles (1420) and (1430). Specifically, top row of FIG. 14 shows the central slice of the reconstructed NCAT phantom (1400) and the ground truth image (1410). Dash lines indicate where the image profiles in bottom rows are taken. Bottom of FIG. 14 shows a comparison of the image profiles between the reconstructed image and ground truth image along a horizontal cut (1420) and a vertical cut (1430).

As shown in 1420 and 1430, the image profiles along the horizontal and the vertical cut in this slice are plotted to demonstrate the detail comparison between ground truth and the reconstruction results. For both image profiles 1420 and 1430, the reconstructed image and the ground-truth are virtually indistinguishable. To quantify the reconstruction accuracy in this case, the RMS error can be computed as

$$e = \frac{{‖ f - {f}_{0} ‖}_{2}}{{‖ {f}_{0} ‖}_{2}} ,$$

where ƒ is the reconstructed image and ƒ₀ is the ground truth image. The reconstructed 3D volumetric CBCT image attains an RMS error of e=1.92% in this case. When the RMS error is computed in the phantom region only, i.e. excluding those background outside the patient, the RMS error can be e=1.67%. These numbers, as well as the figures presented in FIG. 14, demonstrate the ability of the TF algorithm to reconstruct high quality CBCT images.

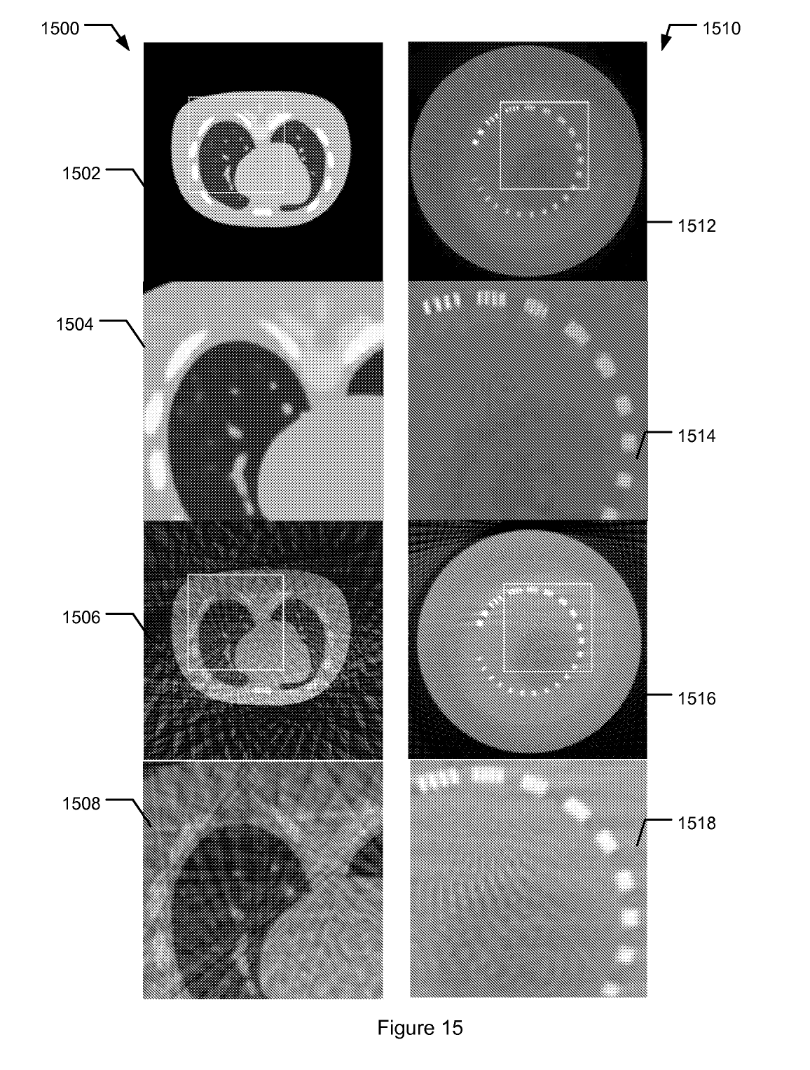

The reconstruction time for this case is about 10 min on an NVIDIA Tesla C1060 card. CBCT can be used in various applications, including for the patient alignment purpose in cancer radiotherapy, where a fast reconstruction is of essential importance. The above described example demonstrates the feasibility of using TF as a regularization approach to reconstruct CBCT given that an enough number of iteration steps are performed. In some clinical practice, such as for positioning patient in cancer radiotherapy, it is adequate to perform less number of iterations for fast image reconstruction, while still yielding acceptable image quality. For this purpose, the iteration process can be terminated earlier (e.g. ˜20 iteration in 2 min). Under this condition, the transverse slice of the reconstructed CBCT images is shown in FIG. 15 for the digital NCAT phantom (left column 1500) and the physical Calphan phantom (1510). Both are reconstructed from 40 projections. For Calphan phantom, the mAs level is 1.0 mAs/projection and was scanned using Varian OBI.

Specifically, FIG. 15 shows reconstruction images using the TF algorithm (1502, 1512) and zoomed-in images (1504, 1514) of (1502, 1512) respectively. For comparison, FIG. 15 shows the same CBCT images reconstructed from the conventional FDK algorithm (1506, 1516) and zoomed-in images (1508, 1518) of (1506, 1516) respectively. Clear streak artifacts are observed in the images produced by the conventional FDK algorithm due to the insufficient number of projections. In contrast, TF algorithm is able to reconstruct better CBCT images even under this extremely under-sampling circumstance.

### Quantitative Analysis

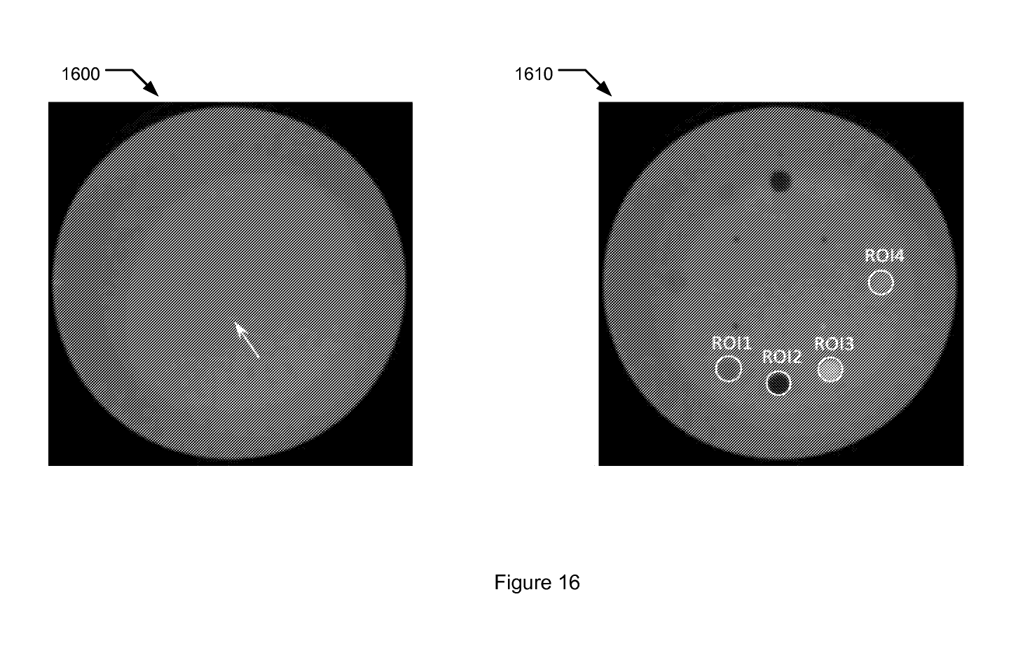

The Calphan phantom contains a layer including a single point-like structure of a diameter 0.28 mm as shown in FIG. 16, image 1600. Specifically, FIG. 16 shows a transverse slice of the Calphan phantom used to measure MTF (1600) and a transverse slice of the Calphan phantom used to measure CNR (1610). This structure allows for the measurement of the in plane modulation transfer function (MTF) of the reconstructed CBCT images, which characterize the spatial resolution inside the transverse plane. For this particular example, a square region of size 21×21 pixel² is cropped in this slice centering at this structure. After subtracting the background, the point spread function can be computed. The MTF is obtained by first performing 2D fast Fourier transform and then averaging the amplitude along the angular direction.

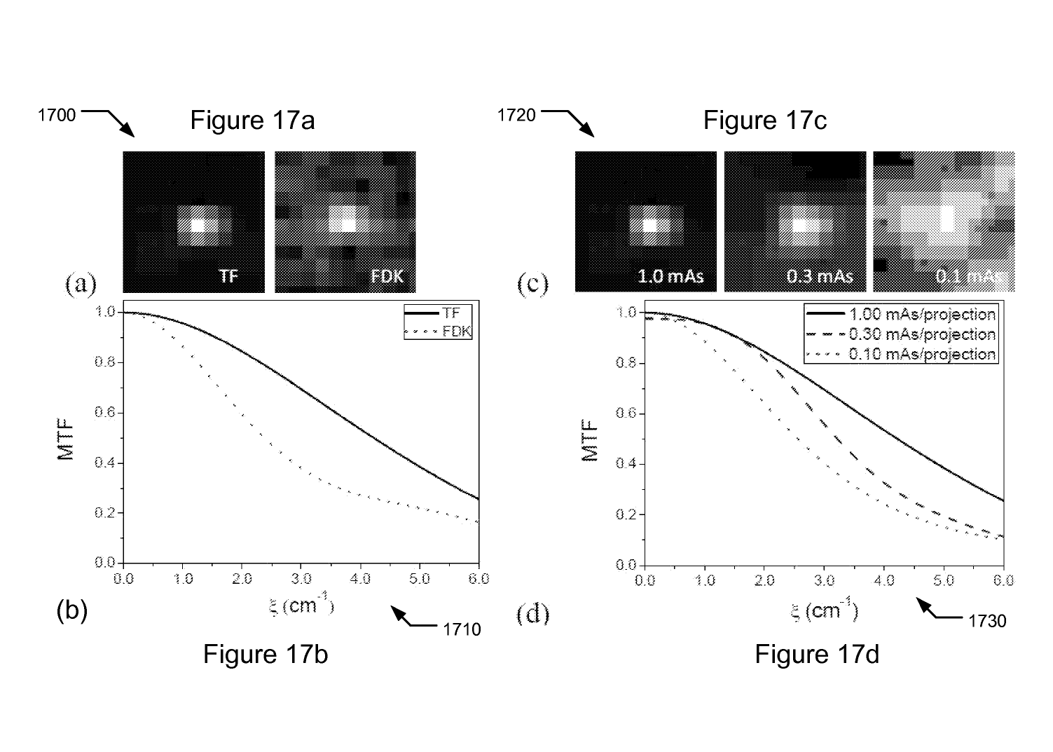

FIG. 17a shows two patches (1700) used to measure MTF in CBCT images reconstructed from TF and FDK algorithms at 1.0 mAs/projection with 40 projections. FIG. 17b shows MTF measurements (1710) obtained from different methods. FIG. 17c shows three patches (1720) used to measure MTF in CBCT images reconstructed from TF method at 1.0, 0.3, and 0.1 mAs/projections with 40 projections. FIG. 17d shows MTF measured at different mAs levels (1730).

At a constant mAs level of 1.0 mAs/projection, the spatial resolution in the images reconstructed from the TF and the FDK algorithms are compared. The patch images used to compute MTF are shown in FIG. 17a and the measured MTF are plotted in FIG. 17b. The TF method results in better MTF curve than FDK method and therefore yields higher spatial resolution on the reconstructed images. For the TF method, the results obtained at different mAs levels and the results are depicted in FIGS. 17c and 17d. The spatial resolution is deteriorated when low mAs level scan is used due to more and more noise component induced in the x-ray projections.

To quantitatively evaluate the contrast of the reconstructed CBCT images, the contrast-to-noise ratio (CNR) can be measured. For a given region of interest (ROI), CNR can be calculated as CNR=2|S−S_{b}|/(σ+σ_{b}), where S and S_{b} are the mean pixel values over the ROI and in the background, respectively, and σ and σ_{b} are the standard deviation of the pixel values inside the ROI and in the background. Before computing the CNR, it should be understood that CNR is affected by the parameter μ which controls to what extent we would like to regularize the solution via the TF term. In fact, a small amount μ is not sufficient to regularize the solution, leading to a high noise level and hence a low CNR. In contrast, a large p tends to over-smooth the CBCT image and reduce the contrast between different structures. Therefore, there exists an optimal μ level in the reconstruction.

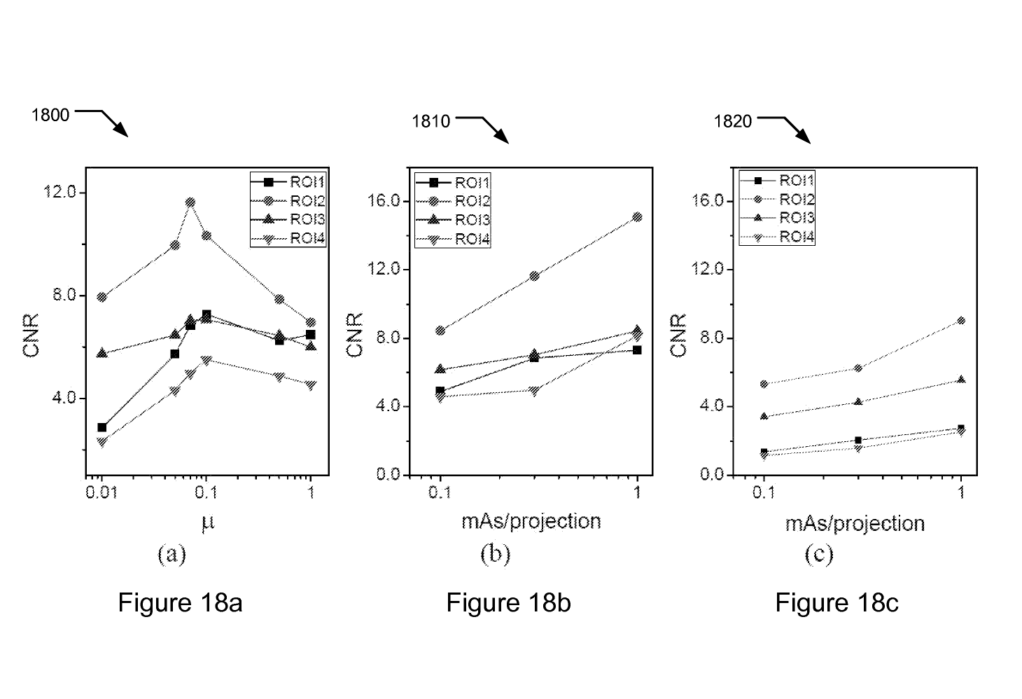

Take the case at 0.3 mAs/projection and 40 projections as an example, CBCT reconstruction can be performed with different μ values and the CNRs can be computed for the four ROIs indicated in FIG. 16, image 1610. The results 1800 are shown in FIG. 18a. The best CNRs are achieved for μ˜0.10. In principle, the optimal parameter could depend on the noise level in the input projection data, which is a function of the system parameters such as mAs levels, number of projections, reconstruction resolution etc. as well as the object being scanned. Throughout this paper, all the reconstruction cases are performed under the optimal μ values except stated explicitly.

FIG. 18b shows the dependence of CNRs on mAs levels measured in those four ROIs in the CBCT images reconstructed using the TF method (1810). The corresponding CNRs obtained from the conventional FDK algorithm are also shown in FIG. 18c (1820). A higher CNR can be achieved when a higher mAs level is used in the CBCT scan, and hence those curves in FIGS. 18b and 18c generally follow a monotonically increasing trend. Moreover, comparing FIGS. 18b and 18c, the described TF-based algorithm yields higher CNRs than the FDK algorithms in all ROIs studied in all cases, indicating better image contrast.

### Patient Case

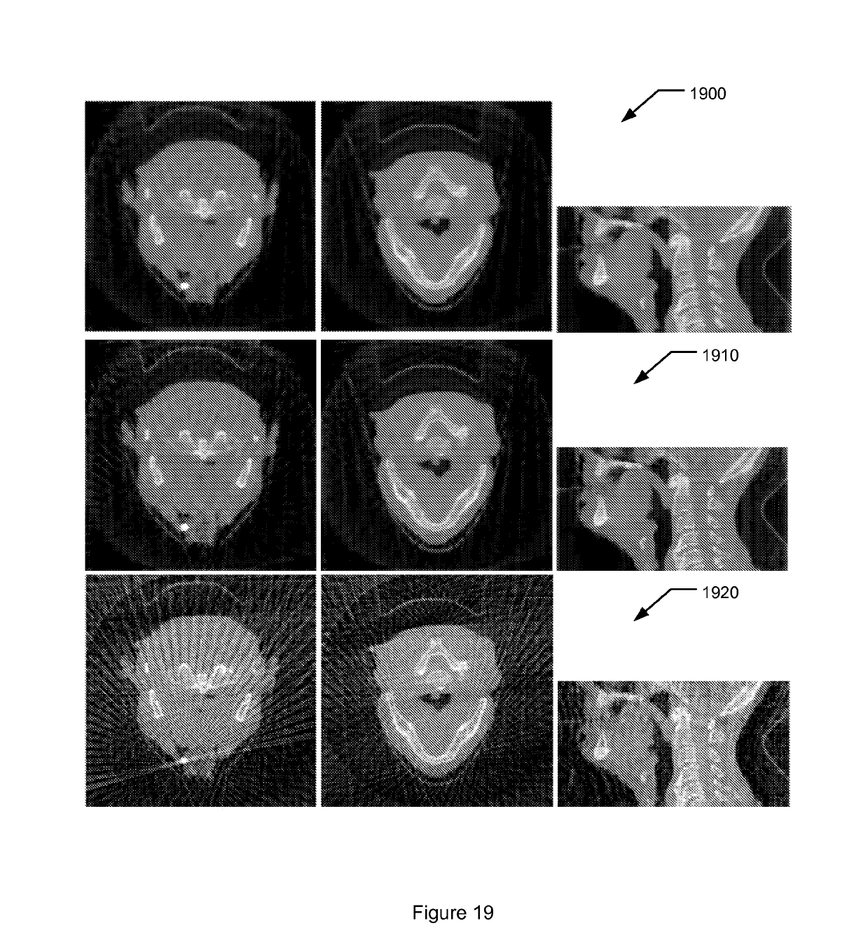

FIG. 19 shows two transverse slices and one sagittal slice of a real head-and-neck patient CBCT reconstructed from TF method with μ=5×10⁻² (first row, 1900), μ=2.5×10⁻² (second row, 1910), and the conventional FDK algorithm (third row, 1920) using 40 projections. As shown in FIG. 19, the described TF-based CBCT reconstruction algorithm is validated on realistic head-and-neck anatomical geometry. A patient's head-and-neck CBCT scan is taken using a Varian OBI system with 0.4 mAs/projection. The reconstruction results obtained from the described TF method are presented with two different parameters μ=5×10⁻² (first row, 1900) and μ=2.5×10⁻² (second row, 1910). In addition, the FDK reconstruction results 1920 are shown in the third row. Due to the complicated geometry and high contrast between bony structures, dental filling, and soft tissues in this head-and-neck region, streak artifacts are severe in the images obtained from FDK algorithm. On the other hand, the described TF-based algorithm successfully captures the main anatomical features while suppressing the streaking artifacts. While comparing the two results from the described TF-based method under different μ values, a large μ value leads to smoother image and less artifacts, though the boundaries of bony structures are slightly blurrier. In contrast, a small p value gives a relatively sharper CBCT image at a cost of some residual streaking artifacts around the dental filling.

### Tangible Useful Applications of TF-Based CBCT

Only a few embodiments have been described of a TF-based fast iterative algorithm for CBCT reconstruction. By iteratively applying three steps to impose three conditions that the reconstructed CBCT should satisfy, high quality CBCT images can be constructed with undersampled and noisy projection data. In particular, the underline assumption that a real CBCT image has a sparse representation under a TF basis is found to be valid and robust in the reconstruction, leading to high quality results. Such an algorithm is mathematically equivalent to the so called balanced approach for TF-based image restoration. In practice, due to the GPU implementation, the multi-grid method, and various techniques employed, high compuational efficiecny can be achieved.

As shown above, the described TF-based algorithm has been tested on a digital NCAT phantom and a physical Calphan phantom. The described TF-based algorithm can lead to higher quality CBCT image than those obtained from a conventional FDK algorithm in the context of undersampling and low mAs scans. Quantitative analysis of the CBCT image quality has been performed with respect to the MTF and CNR under various scanning cases, and the results confirm the high CBCT image quality obtained from the described TF-based algorithm. Moreover, reconstructions performed on a head-and-neck patient have presented very promissing results in real clinical applications.

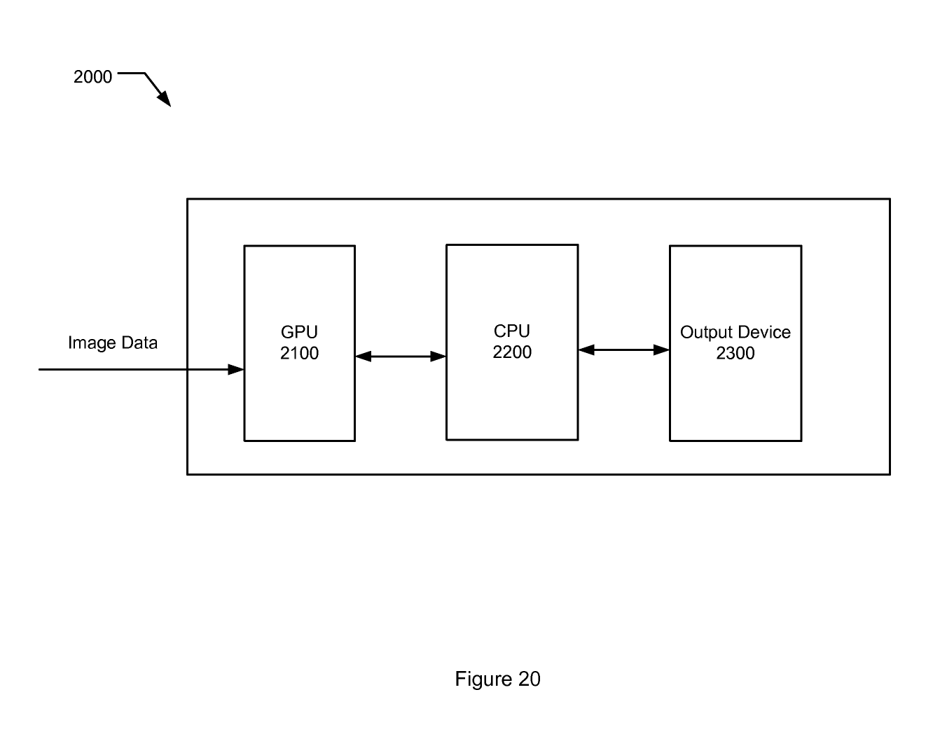

FIG. 20 is a block diagram of a computing system 2000 for performing the CBCT reconstruction as described above. The system 2000 includes a graphics processing unit (GPU) 2100, a central processing unit (CPU) 2200 and a output device 2300. The GPU 2100 is substantially as described above including NVIDIA's CPU devices. The central processing unit 2200 can include any of the data processing chips well know in the art. The output device can include a display device such as a liquid crystal display, a printer and even a storage device, such as a hard drive, flash memory etc. Moreover, the system 2000 can include additional components such as local memory and storage units and the corresponding interconnects.

A few embodiments have been described in detail above, and various modifications are possible. The disclosed subject matter, including the functional operations described in this specification, can be implemented in electronic circuitry, computer hardware, firmware, software, or in combinations of them, such as the structural means disclosed in this specification and structural equivalents thereof, including potentially a program operable to cause one or more data processing apparatus to perform the operations described (such as a program encoded in a computer-readable medium, which can be a memory device, a storage device, a machine-readable storage substrate, or other physical, machine-readable medium, or a combination of one or more of them).

The term “data processing apparatus” or “computing system’ encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A program (also known as a computer program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A program can be deployed to be executed on one computer or on multiple computers that are located at one site or distributed across multiple sites and interconnected by a communication network.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Only a few implementations and examples are described and other implementations, enhancements and variations can be made based on what is described and illustrated in this application including the attached Appendix.

What is claimed is:

1. A graphics processor unit (GPU) implemented method of reconstructing a cone beam computed tomography (CBCT) image, the GPU implemented method comprising:
receiving, at the GPU, image data for CBCT reconstruction;
using an iterative process to minimize an energy functional component of the received image data, wherein the energy functional component comprises a data fidelity term and a data regularization term; and
generating the reconstructed CBCT image based on the minimized energy functional component.

2. The GPU implemented method of claim 1, wherein the received image data comprises volumetric information projected using x-ray projections onto an x-ray imager plane in a cone beam geometry along a number of projection angles.

3. The GPU implemented method of claim 2, wherein the fidelity term indicates consistency between the reconstructed CBCT image and an observed image from the number of projection angles.

4. The GPU implemented method of claim 1, wherein the data regularization term comprises a total variation regularization term.

5. The GPU implemented method of claim 1, wherein the using an iterative process to minimize an energy functional component of the received image data comprises:
using an algorithm that minimizes the data regularization term and the data fidelity term in two alternating steps.

6. The GPU implemented method of claim 2, wherein using the algorithm that minimizes the data regularization term and the data fidelity term in two alternating steps comprises an iterative algorithm comprising:
(a) performing a gradient descent update with respect to minimization of the data fidelity term;
(b) perform Rudin-Osher-Fatemi model minimization to remove noise and artifacts while preserving sharp edges and main features;
(c) perform truncation to ensure non-negativeness of the reconstructed image; and
(d) repeat (a)-(c) until a desired minimization of the energy functional component is reached.

7. A computer implemented method of reconstructing a cone beam computed tomography (CBCT) image, the computer implemented method comprising:
receiving, at the computer, image data for CBCT reconstruction;
using an iterative conjugate gradient least square (CGLS) algorithm to minimize an energy functional component; and
generating the reconstructed CBCT image based on the minimized energy functional component.

8. The computer implemented method of claim 7, wherein the received image data comprises volumetric information projected using x-ray projections onto an x-ray imager plane in a cone beam geometry along a number of projection angles.

9. The computer implemented method of claim 8, wherein the iterative CGCL algorithm begins with an initial guess and repeatedly minimizes the energy functional component until the reconstructed CBCT image is obtained.

10. The computer implemented method of claim 8, wherein the iterative CGCL algorithm ensures consistency between the reconstructed CBCT image and an observation image from the number of projection angles.

11. The computer implemented method of claim 7, wherein the iterative CGCL algorithm imposes a tight frame regularization condition.

12. The computer implemented method of claim 11, wherein imposing a tight frame regularization condition comprises:
decomposing the reconstructed image into a set of coefficients using a convolution function.

13. The computer implemented method of claim 7, wherein the method is performed by a graphics processing unit (GPU).

14. A computing system for reconstructing a cone beam computed tomography (CBCT) image, the computing system comprising:
a graphics processing unit (GPU) to perform CBCT reconstruction comprising:
receiving image data for CBCT reconstruction,
using an iterative process to minimize an energy functional component of the received image data, wherein the energy functional component comprises a data fidelity term and a data regularization term, and
generating the reconstructed CBCT image based on the minimized energy functional component; and
a central processing unit (CPU) to receive the generated CBCT image for output.

15. The computing system of claim 14, wherein the received image data comprises volumetric information projected using x-ray projections onto an x-ray imager plane in a cone beam geometry along a number of projection angles.

16. The computing system of claim 15, wherein the fidelity term indicates consistency between the reconstructed CBCT image and an observed image from the number of projection angles.

17. The computing system of claim 14, wherein the data regularization term comprises a total variation regularization term.

18. The computing system of claim 14, wherein the iterative process to minimize an energy functional component of the received image data comprises:
an algorithm that minimizes the data regularization term and the data fidelity term in two alternating steps.

19. The computing system of claim 15, wherein the algorithm that minimizes the data regularization term and the data fidelity term in two alternating steps comprises an iterative algorithm comprising:
(a) a gradient descent update with respect to minimization of the data fidelity term;
(b) Rudin-Osher-Fatemi model minimization to remove noise and artifacts while preserving sharp edges and main features;
(c) truncation to ensure non-negativeness of the reconstructed image; and
(d) repeating (a)-(c) until a desired minimization of the energy functional component is reached.

20. A computing system for reconstructing a cone beam computed tomography (CBCT) image, the computing system comprising:
a graphics processing unit (GPU) to perform the CBCT reconstruction comprising:
receiving image data for CBCT reconstruction,
using an iterative conjugate gradient least square (CGLS) algorithm to minimize an energy functional component, and
generating the reconstructed CBCT image based on the minimized energy functional component; and
a central processing unit (CPU) to receive the reconstructed CBCT image for output.

21. The computing system of claim 20, wherein the received image data comprises volumetric information projected using x-ray projections onto an x-ray imager plane in a cone beam geometry along a number of projection angles.

22. The computing system of claim 21, wherein the GPU performs the iterative CGCL algorithm by beginning with an initial guess and repeatedly minimizes the energy functional component until the reconstructed CBCT image is obtained.

23. The computing system of claim 21, wherein the iterative CGCL algorithm ensures consistency between the reconstructed CBCT image and an observation image from the number of projection angles.

24. The computing system of claim 20, wherein the GPU uses the iterative CGCL algorithm to impose a tight frame regularization condition.

25. The computing system of claim 24, wherein the GPU is configured to impose the tight frame regularization condition by decomposing the reconstructed image into a set of coefficients using a convolution function.
